(19) United States
(12) Patent Application Publication
(10) Pub. No.: US 2013/0079449 A1
(43) Pub. Date: Mar. 28, 2013

(54) Polymer Composition and Method

(71) Applicant: R. Shawn Childress, Bartlesville, OK (US)

(72) Inventor: R. Shawn Childress, Bartlesville, OK (US)

(21) Appl. No.: 13/240,324

(22) Filed: Sep. 22, 2011

(51) Int. Cl. C08L 81/04; C08K 3/26; C08K 3/22; C08K 3/40; C08K 3/08; C08K 3/36; C08K 3/04; C08K 3/34; C08K 3/10

(52) U.S. Cl. 524/413; 525/537; 524/609; 524/456; 524/449; 524/451; 524/445; 524/425; 524/436; 524/441; 524/440; 524/452

(57) ABSTRACT

Disclosed herein are compositions comprising a polymer and a carbamate. Also disclosed are methods of preparing these compositions, as well as methods of using these compositions to prepare additional polymer compositions. These compositions are useful as polymer compositions for molded articles or for preparing polymer compositions of molded articles.

### TECHNICAL FIELD OF THE INVENTION

This invention relates to processing polymer compositions, such as polyarylene sulfide, polyarylene sulfone, and related polymers.

### BACKGROUND OF THE INVENTION

Polyphenylene sulfide, a member of a more general class of polymers known as poly(arylene) sulfide, is a high-performance engineering thermoplastic that can be heated and molded into desired shapes for a variety of manufacturing, commercial, and consumer applications. Polyphenylene sulfide can be used in the preparation of fibers, films, coatings, injection molding compounds, and fiber-reinforced composites. Polyphenylene sulfide can be incorporated as a manufacturing component either alone or in a blend with other materials, such as other polymers, resins, reinforcing agents, additives, and other thermoplastics, among others. Initially, polyphenylene sulfide was promoted as a replacement for thermosetting materials, but has become a suitable molding material, especially with the addition of glass and carbon fibers, minerals, and fillers, among others. In fact, polyphenylene sulfide is one of the oldest high-performance injection molding plastics in the polymer industry, with non-filled grades commonly extruded as wire coatings.

Polyphenylene sulfide is an attractive engineering plastic because, in part, it can provide an excellent combination of properties. For example, polyphenylene sulfide can provide resistance to aggressive chemical environments while also providing precision molding to tight tolerances. Further, polyphenylene sulfide can be thermally stable, can be inherently non-flammable without flame retardant additives, and can possess excellent dielectric/insulating properties. Other properties can include dimensional stability, high modulus, and creep resistance. The beneficial properties of polyphenylene sulfide can be due, in part, to the stable chemical bonds of its molecular structure, which can impart a relatively high degree of molecular stability. Consequently, polyphenylene sulfide can have a high degree of resistance toward thermal degradation and chemical resistance.

Polyphenylene sulfide can be blended or compounded with various additives to provide desired properties. Polyphenylene sulfide can be heated, melted, extruded, and molded into desired shapes and composites in a variety of processes, equipment, and operations. Polyphenylene sulfide can be subjected to heat, compounding, injection molding, blow molding, precision molding, filmblowing, extrusion, and so forth, depending on the desired application.

### SUMMARY OF THE INVENTION

In an aspect, the present disclosure relates to a composition comprising a) a polymer composition comprising a poly(arylene sulfide), a poly(arylene sulfone), a copolymer of a poly(arylene sulfide) and a poly(arylene sulfone), or any combination thereof, and b) a carbamate. In another aspect, the present disclosure relates to a method of forming a composition comprising 1) contacting a) a polymer composition comprising a poly(arylene sulfide), a poly(arylene sulfone), a copolymer of a poly(arylene sulfide) and a poly(arylene sulfone), or any combination thereof and b) a carbamate to form a mixture and 2) melt processing the mixture. In yet another aspect, the present disclosure relates to a method of forming a composition comprising 1) contacting a) a melt processed mixture formed from a first mixture comprising i) a first polymer composition comprising a poly(arylene sulfide), a poly(arylene sulfone), a copolymer of a poly(arylene sulfide) and a poly(arylene sulfone), or any combination thereof, and ii) a carbamate, and b) a second polymer composition comprising a poly(arylene sulfide), a poly(arylene sulfone), a copolymer of a poly(arylene sulfide) and a poly(arylene sulfone), or any combination thereof to form a second mixture and 2) melt processing the second mixture. In yet a further aspect, the present disclosure relates to a method of forming a composition comprising 1) contacting a) a first mixture comprising i) a first polymer composition comprising a poly(arylene sulfide), a poly(arylene sulfone), a copolymer of a poly(arylene sulfide) and a poly(arylene sulfone), or any combination thereof, and ii) a carbamate, 2) melt processing the first mixture, 3) contacting the melt processed first mixture with a second polymer composition comprising a poly(arylene sulfide), a poly(arylene sulfone), a copolymer of a poly(arylene sulfide) and a poly(arylene sulfone), or any combination thereof to form a second mixture, and 4) melt processing the second mixture. In another aspect, the present disclosure relates to a method of forming a composition comprising 1) contacting a) a first mixture comprising i) a first polymer composition comprising a poly(arylene sulfide), a poly(arylene sulfone), a copolymer of a poly(arylene sulfide) and a poly(arylene sulfone), or any combination thereof, and ii) a carbamate, and b) a second polymer composition comprising a poly(arylene sulfide), a poly(arylene sulfone), a copolymer of a poly(arylene sulfide) and a poly(arylene sulfone), or any combination thereof, to form a second mixture, and 2) melt processing the second mixture.

In an embodiment, the polymer (general, first, second, or other) of the polymer composition (general, first, second, or other) can comprise a poly(arylene sulfide); or alternatively, a poly(phenylene sulfide). In an aspect the carbamate (general, first, second, or other) can have the formula R⁴(NHCO₂R³)_{y}; or alternatively, the formula Rₓ(R¹O)₃₋ₓSiR²NHCO₂R³. In an embodiment, where the carbamate has the formula R⁴(NHCO₂R³)_{y}, y can be 1, 2, or 3, R³ can be a C₁ to C₁₀ organic group and R can be a C₁ to C₈₀ organic group. In an embodiment where the carbamate can have the formula R⁴(NHCO₂R³)_{y}, R³ can be a C₁ to C₁₀ hydrocarbyl group, y can be 2, and R⁴ can be a C₁ to C₃₀ hydrocarbylene group; or alternatively, R³ can be a C₁ to C₁₀ hydrocarbyl group, y can be 1, and R⁴ can be a C₁ to C₂₀ hydrocarbyl group. In an embodiment where the carbamate can have the formula Rₓ(R¹O)₃₋ₓSiR²NHCO₂R³, x can be 0, 1, 2, or 3, each R and R¹ independently can be a C₁ to C₂₀ organic group, R² can be a C₁ to C₂₀ organylene group, and R³ can be a C₁ to C₁₀ organic group. In another embodiment where the carbamate can have the formula Rₓ(R¹O)₃₋ₓSiR²NHCO₂R³, x can be 0, 1, or 2, each R and R¹ independently can be a C₁ to C₁₀ hydrocarbyl group, R² can be a C₁ to C₁₀ hydrocarbylene group, and R³ can be a C₁ to C₁₀ hydrocarbyl group; alternatively, x can be 0; each R¹ independently can be a methyl group or an ethyl group, R² can be a methylene group, an ethylene group, or a propylene group, and R³ can be a methyl group or an ethyl group.

### BRIEF DESCRIPTION OF THE FIGURES

FIG. 1 provides a graphical comparison of the tensile strength for melt processed poly(phenylene sulfide) (the control), poly(phenylene sulfide) melt processed in the presence of an isocyanate (TMSP-ISO, TESP-ISO, and TMSGP-ISO), and poly(phenylene sulfide) melt processed in the presence of a carbamate (TMSP-CAR and TESP-CAR).

FIG. 2 provides a graphical comparison of the elongation for melt processed poly(phenylene sulfide) (the control), poly(phenylene sulfide) melt processed in the presence of an isocyanate (TMSP-ISO, TESP-ISO, and TMSGP-ISO), and poly(phenylene sulfide) melt processed in the presence of a carbamate (TMSP-CAR and TESP-CAR).

FIG. 3 provides a graphical comparison of the break deflection for melt processed poly(phenylene sulfide) (the control), poly(phenylene sulfide) melt processed in the presence of an isocyanate (TMSP-ISO, TESP-ISO, and TMSGP-ISO), and poly(phenylene sulfide) melt processed in the presence of a carbamate (TMSP-CAR and TESP-CAR).

FIG. 4 provides a graphical comparison of the flex breakthrough strength for melt processed poly(phenylene sulfide) (the control), poly(phenylene sulfide) melt processed in the presence of an isocyanate (TMSP-ISO, TESP-ISO, and TMSGP-ISO), and poly(phenylene sulfide) melt processed in the presence of a carbamate (TMSP-CAR and TESP-CAR).

FIG. 5 provides a graphical comparison of the maximum load for melt processed poly(phenylene sulfide) (the control), poly(phenylene sulfide) melt processed in the presence of an isocyanate (TMSP-ISO, TESP-ISO, and TMSGP-ISO), and poly(phenylene sulfide) melt processed in the presence of a carbamate (TMSP-CAR and TESP-CAR).

FIG. 6 provides a graphical comparison of the notched IZOD for melt processed poly(phenylene sulfide) (the control), poly(phenylene sulfide) melt processed in the presence of an isocyanate (TMSP-ISO, TESP-ISO, and TMSGP-ISO), and poly(phenylene sulfide) melt processed in the presence of a carbamate (TMSP-CAR and TESP-CAR).

FIG. 7 provides a graphical comparison of the unnotched IZOD for melt processed poly(phenylene sulfide) (the control), poly(phenylene sulfide) melt processed in the presence of an isocyanate (TMSP-ISO, TESP-ISO, and TMSGP-ISO), and poly(phenylene sulfide) melt processed in the presence of a carbamate (TMSP-CAR and TESP-CAR).

### DETAILED DESCRIPTION OF THE INVENTION

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements are indicated using the numbering scheme indicated in the version of the periodic table of elements published in Chemical and Engineering News, 63(5), 27, 1985. In some instances a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Absent an indication to the contrary, when describing a compound or composition “consisting essentially of” is not to be construed as “comprising,” but is intended to describe the recited component that includes materials which do not significantly alter the composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to the feature class in which it is utilized and it is possible to have different transitional terms or phrases utilized with different features within a claim. For example, a method can comprise several recited steps (and other non-recited steps) but utilize a composition consisting of specific or a composition comprising recited components and other non-recited components.

Within this specification, use of “comprising” or an equivalent expression contemplates the use of the phrase “consisting essentially of,” “consists essentially of,” or equivalent expression as an alternative embodiment to the open-ended expression. Additionally, use of “comprising” or an equivalent expression or use of “consisting essentially of” in the specification contemplates the use of the phrase “consisting of,” “consists of,” or equivalent expression as an alternative to the open-ended expression or middle ground expression, respectively. For example, “comprising” should be understood to include “consisting essentially of,” and “consisting of” as alternative embodiments for the aspect, features, and/or elements presented in the specification unless specifically indicated otherwise.

The terms “independently selected,” “independently can be,” or an equivalent are used herein to indicate that the recited elements (e.g., X, X¹, X², X³) can be identical or different (e.g., X, X¹, X², and X³ can all be methyl groups, or X can be hydrogen, X¹ can be a methyl groups and X² and X³ be a phenyl group, etc. . . . ). Additionally, if a structure can have multiple occurrences of a group (e.g. C(OR)₄, use of the term “independently selected” or “independently can be” indicates that each occurrence of the recited group is independent from the other (e.g. in C(OR)₄, each OR group can be OMe or one OR can be OMe, another OR can be OEt, another OR can be OPh, and the last OR can be Ot-Bu).

The terms “a,” “an,” and “the” are intended, unless specifically indicated otherwise, to include plural alternatives, e.g., at least one. For instance, the disclosure of “a carbamate” or “the carbamate” is meant to encompass one carbamate, or mixtures or combinations of more than one carbamate unless otherwise specified.

For any particular compound disclosed herein, the general structure or name presented is also intended to encompass all structural isomers, conformational isomers, and stereoisomers that can arise from a particular set of substituents, unless indicated otherwise. Thus, a general reference to a compound includes all structural isomers unless explicitly indicated otherwise; e.g., a general reference to pentane includes n-pentane, 2-methyl-butane, and 2,2-dimethylpropane while a general reference to a butyl group includes an n-butyl group, a sec-butyl group, an iso-butyl group, and a tert-butyl group. Additionally, the reference to a general structure or name encompasses all enantiomers, diastereomers, and other optical isomers whether in enantiomeric or racemic forms, as well as mixtures of stereoisomers, as the context permits or requires. For any particular formula or name that is presented, any general formula or name presented also encompasses all conformational isomers, regioisomers, and stereoisomers that can arise from a particular set of substituents.

The term “polymer,” whenever used in this specification and claims, refers to a composition comprising at least one compound produced from one or more monomers or alternatively have one or more repeating units. The term “polymer” can be further qualified by indicating the class of monomer(s) and/or the specific monomer(s) which minimally must be present in the polymer. The term “homopolymer,” whenever used in this specification and claims, refers to a composition comprising at least one compound produced from essentially one monomer or alternatively consists essentially of one repeating unit. The term “homopolymer” can be further qualified by indicating the class of monomer and/or the specific monomer from which the polymer is prepared. The term “copolymer” whenever used in this specification and claims refers to a polymer produced using at least two different monomers or alternatively having at least two different repeating units. For example, a copolymer of poly(arylene sulfide) and poly(arylene sulfone) is a polymer having poly(arylene sulfide) units and poly(arylene sulfone) units.

A chemical “group” is described according to how that group is formally derived from a reference or “parent” compound, for example, by the number of hydrogen atoms formally removed from the parent compound to generate the group, even if that group is not literally synthesized in this manner These groups can be utilized as substituents or coordinated or bonded to metal atoms. By way of example, an “alkyl group” formally can be derived by removing one hydrogen atom from an alkane, while an “alkylene group” formally can be derived by removing two hydrogen atoms from an alkane. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials have three or more hydrogens atoms, as necessary for the situation, removed from the alkane. Throughout, the disclosure that a substituent, ligand, or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedure, unless specified otherwise or the context requires otherwise. Moreover, other identifiers or qualifying terms can be utilized to indicate the presence or absence of a particular substituent, a particular regiochemistry and/or stereochemistry, or the presence or absence of a branched underlying structure or backbone.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen can include, but is not limited to, halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (C(O)H), a carboxy group (—C(O)OH), a hydrocarboxycarbonyl group (—C(O)OR), a cyano group (—C≡N), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂, and the like. An “organyl group,” “organylene group,” or “organic group” can be aliphatic, inclusive of being cyclic or acyclic, or can be aromatic. “Organyl groups,” “organylene groups,” and “organic groups” also can encompass heteroatom-containing rings, heteroatom-containing ring systems, heteroaromatic rings, and heteroaromatic ring systems. “Organyl groups,” “organylene groups,” and “organic groups” can be linear or branched unless otherwise specified. Finally, it is noted that the “organyl group,” “organylene group,” or “organic group” definitions include “hydrocarbyl group,” “hydrocarbylene group,” “hydrocarbon group,” respectively, and “alkyl group,” “alkylene group,” and “alkane group,” respectively, as members. Other members of “organyl groups,” “organylene groups,” and “organic groups” are readily apparent from definition provided in this disclosure.

The term “hydrocarbon” whenever used in this specification and claims refers to a compound containing only carbon and hydrogen. Other identifiers can be utilized to indicate the presence of particular groups in the hydrocarbon (e.g. halogenated hydrocarbon indicates that the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Non-limiting examples of hydrocarbyl groups include ethyl, phenyl, tolyl, propenyl, and the like. Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or can be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane group, cycloalkyl, cycloalkylene, cycloalkane groups, aralkyl, aralkylene, and aralkane groups, respectively, among other groups as members. Other members of “hydrocarbyl groups,” “hydrocarbylene groups,” and “hydrocarbon groups” are readily apparent from definition provided in this disclosure.

An aliphatic compound is an acyclic or cyclic, saturated or unsaturated, carbon compound, excluding aromatic compounds. An “aliphatic group” is a generalized group formed by removing one or more hydrogen atoms (as necessary for the particular group) from carbon atom of an aliphatic compound. Aliphatic compounds and aliphatic groups can contain organic functional group(s) and/or atom(s) other than carbon and hydrogen.

The term “alkane” whenever used in this specification and claims refers to a saturated hydrocarbon compound. Other identifiers can be utilized to indicate the presence of particular groups in the alkane (e.g. halogenated alkane indicates that the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic, and/or can be linear or branched unless otherwise specified.

A cycloalkane is a saturated cyclic hydrocarbon, with or without side chains, for example, cyclobutane. Unsaturated cyclic hydrocarbons having one or more endocyclic double or one triple bond are called cycloalkenes and cycloalkynes, respectively. Cycloalkenes and cycloalkynes having only one, only two, and only three endocyclic double or triple bonds, respectively, can be identified by use of the term “mono,” “di,” and “tri within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g. halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom of a cycloalkane. For example, a 1-methylcyclopropyl group and a 2-methylcyclopropyl group are illustrated as follows.

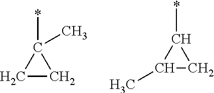

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g. a methylcyclopropyl group) and is member of the group of hydrocarbon groups. However, when referring to a cycloalkane group having a specified number of cycloalkane ring carbon atoms (e.g. cyclopentane group or cyclohexane group, among others), the base name of the cycloalkane group having a defined number of cycloalkane ring carbon atoms refers to the unsubstituted cycloalkane group. Consequently, a substituted cycloalkane group having a specified number of ring carbon atoms (e.g. substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One can readily discern and select general groups, specific groups, and/or individual substituted cycloalkane group(s) having a specific number of ring carbons atoms which can be utilized as member of the hydrocarbon group (or a member of the general group of cycloalkane groups).

An aromatic compound is a compound containing a cyclically conjugated double bond system that follows the Hückel (4n+2) rule and contains (4n+2) pi-electrons, where n is an integer from 1 to 5. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2). While arene compounds and heteroarene compounds are mutually exclusive members of the group of aromatic compounds, a compound that has both an arene group and a heteroarene group are generally considered a heteroarene compound. Aromatic compounds, arenes, and heteroarenes can be monocyclic (e.g., benzene, toluene, furan, pyridine, methylpyridine) or polycyclic unless otherwise specified. Polycyclic aromatic compounds, arenes, and heteroarenes, include, unless otherwise specified, compounds wherein the aromatic rings can be fused (e.g., naphthalene, benzofuran, and indole), compounds where the aromatic groups can be separate and joined by a bond (e.g., biphenyl or 4-phenylpyridine), or compounds where the aromatic groups are joined by a group containing linking atoms (e.g., carbon—the methylene group in diphenylmethane; oxygen—diphenyl ether; nitrogen—triphenyl amine; among others linking groups). As disclosed herein, the term “substituted” can be used to describe an aromatic group, arene, or heteroarene wherein a non-hydrogen moiety formally replaces a hydrogen in the compound, and is intended to be non-limiting.

An “aromatic group” refers to a generalized group formed by removing one or more hydrogen atoms (as necessary for the particular group and at least one of which is an aromatic ring carbon atom) from an aromatic compound. For a univalent “aromatic group,” the removed hydrogen atom must be from an aromatic ring carbon. For an “aromatic group” formed by removing more than one hydrogen atom from an aromatic compound, at least one hydrogen atom must be from an aromatic hydrocarbon ring carbon. Additionally, an “aromatic group” can have hydrogen atoms removed from the same ring of an aromatic ring or ring system (e.g., phen-1,4-ylene, pyridin-2,3-ylene, naphth-1,2-ylene, and benzofuran-2,3-ylene), hydrogen atoms removed from two different rings of a ring system (e.g., naphth-1,8-ylene and benzofuran-2,7-ylene), or hydrogen atoms removed from two isolated aromatic rings or ring systems (e.g., bis(phen-4-ylene)methane).

An arene is aromatic hydrocarbon, with or without side chains (e.g. benzene, toluene, or xylene, among others). An “aryl group” is a group derived by the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here.

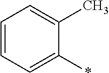 [SMILES: *c1ccccc1C]

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g. the phenyl and benzofuran moieties in 7-phenyl-benzofuran) its classification depends upon the particular ring or ring system from which the hydrogen atom was removed, that is, a substituted arene group if the removed hydrogen came from the aromatic hydrocarbon ring or ring system carbon atom (e.g. the 2 carbon atom in the phenyl group of 6-phenylbenzofuran) and a heteroarene group if the removed hydrogen carbon came from a heteroaromatic ring or ring system carbon atom (e.g. the 2 or 7 carbon atom of the benzofuran group of 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g. a toluene group or a xylene group, among others) and is a member of the group of hydrocarbon groups. However, a phenyl group (or phenylene group) and/or a naphthyl group (or naphthylene group) refer to the specific unsubstituted arene groups. Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphtyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

An “aralkyl group” is an aryl-substituted alkyl group having a free valance at a non-aromatic carbon atom (e.g. a benzyl group, or a 2-phenyleth-1-yl group, among others). Similarly, an “aralkylene group” is an aryl-substituted alkylene group having two free valencies at a single non-aromatic carbon atom or a free valence at two non-aromatic carbon atoms while an “aralkane group” is a generalized is an aryl-substituted alkane group having one or more free valencies at a non-aromatic carbon atom(s). A “heteroaralkyl group” is a heteroaryl-substituted alkyl group having a free valence at a non-heteroaromatic ring or ring system carbon atom. Similarly a “heteroaralkylene group” is a heteroaryl-substituted alkylene group having two free valencies at a single non-heteroaromatic ring or ring system carbon atom or a free valence at two non-heteroaromatic ring or ring system carbon atoms while a “heteroaralkane group” is a generalized aryl-substituted alkane group having one or more free valencies at a non-heteroaromatic ring or ring system carbon atom(s). It should be noted that according the definitions provided herein, general aralkane groups include those having zero, one, or more than one hydrocarbyl substituent groups located on an aralkane aromatic hydrocarbon ring or ring system carbon atom and is a member of the group of hydrocarbon groups. However, specific aralkane groups specifying a particular aryl group (e.g. the phenyl group in a benzyl group or a 2-phenylethyl group, among others) refer to the specific unsubstituted aralkane groups. Consequently, a substituted aralkane group specifying a particular aryl group refers to a respective aralkane group having one or more substituent groups (including halogens, hydrocarbyl groups, or hydrocarboxy groups, among others). When the substituted aralkane group specifying a particular aryl group is a member of the group of hydrocarbon groups (or a member of the general group of aralkane groups), each substituent is limited to a hydrocarbyl substituent group. One can readily discern and select substituted aralkane groups specifying a particular aryl group which can be utilized as a member of the group of hydrocarbon groups (or a member of the general group of aralkane groups).

In an aspect, the present disclosure relates to a composition comprising a polymer and a carbamate. In another aspect, the present disclosure relates to a composition comprising a) a polymer composition (general, first, second, or other) comprising, or consisting essentially of, i) a polymer (general, first, second, or other) and ii) a carbamate (general, first, second, or other). In an aspect, the composition comprising a polymer and a carbamate, composition comprising a) a polymer composition comprising, or consisting essentially of, i) a polymer and ii) a carbamate, and/or mixture produced from a polymer composition comprising a polymer and a carbamate can comprise a reaction product of the polymer and the carbamate. In some embodiments, the reaction product can be produced by melt processing the composition, polymer composition, and/or mixture. Depending upon the ratios and conditions utilized to form the reaction product of the polymer and the carbamate, the composition comprising a reaction product of the polymer and the carbamate can comprise, or consist essentially of, a mixture of the polymer, the carbamate, and the reaction product; alternatively, a mixture of the polymer and the reaction product; or alternatively, a mixture of the carbamate and the reaction product. In an embodiment, the composition and/or mixture can also include one or more additives.

The polymer compositions, polymers, carbamates, and additives are independent elements of the composition and are independently described herein. As such the composition can be described using any combination of the polymer composition described herein, the polymer described herein, the carbamate described herein, and/or the additives described herein.

In an embodiment, the polymer (general, first, second, or other) of the polymer composition (general, first, second, or other) can comprise, or consist essentially of, a poly(arylene sulfide), a poly(arylene sulfone), and a copolymer of a poly(arylene sulfide) and a poly(arylene sulfone) or any combination thereof; alternatively, a poly(arylene sulfide); alternatively, a poly(arylene sulfone); or alternatively, a copolymer of a poly(arylene sulfide) and a poly(arylene sulfone). In some embodiments, the polymer (general, first, second, or other) of the polymer composition (general, first, second, or other) can comprise, or consist essentially of, a poly(phenylene sulfide), a poly(phenylene sulfone), a copolymer of a poly(arylene sulfide) and a poly(arylene sulfone), or a combination thereof; alternatively, a poly(phenylene sulfide); alternatively, a poly(phenylene sulfone); or alternatively, a copolymer of a poly(arylene sulfide) and a poly(arylene sulfone). The polymer of the polymer composition can in any form, including a raw polymer, cured polymer, or a polymer processed (e.g., melt processed, among other process forms) into an easily handled form such as pellets; alternatively, a raw polymer; alternatively, a cured polymer, or a processed polymer.

In an aspect, poly(arylene sulfide) is a polymer comprising a —(Ar—S)— unit, wherein Ar is an arylene group. Unless otherwise specified the arylene groups of the poly(arylene sulfide) can be substituted or unsubstituted. Additionally, unless otherwise specified the poly(arylene sulfide) can include any isomeric relationship of the sulfide linkages in polymer; e.g. when the arylene group is a phenylene group the sulfide linkages can be ortho, meta, para, or combinations thereof.

In an aspect, poly(arylene sulfide) can contain at least 5, 10, 20, 30, 40, 50, 60, 70 mole percent of the —(Ar—S)— unit. In an embodiment, poly(arylene sulfide) can contain up to 50, 70, 80, 90, 95, 99, or 100 mole percent of the —(Ar—S)— unit. In some embodiments, poly(arylene sulfide) can contain from any minimum mole percent of the —(Ar—S)— unit disclosed herein to any maximum mole percent of the —(Ar—S)— unit disclosed herein; for example from 5 to 99 mole percent, 30 to 70 mole percent, or 70 to 95 mole percent of the —(Ar—S)— unit. Poly(arylene sulfide) containing less than 100 percent —(Ar—S)— can further comprise one or more units having structure

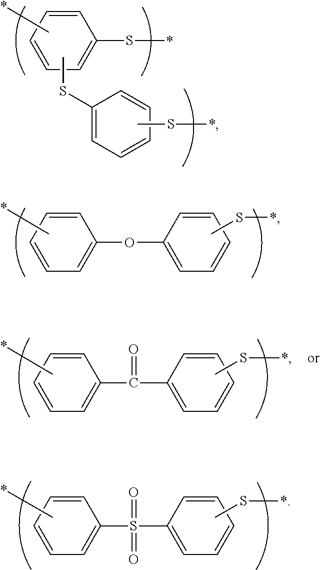

In an aspect, poly(arylene sulfone) is a polymer comprising a —(Ar—SO₂)— unit, wherein Ar is an arylene group. Unless otherwise specified the arylene groups of the poly(arylene sulfone) can be substituted or unsubstituted. Additionally, unless otherwise specified the poly(arylene sulfone) can include any isomeric relationship of the sulfone linkages in polymer; e.g. when the arylene group is a phenylene group the sulfone linkages can be ortho, meta, para, or combinations thereof.

In an aspect, poly(arylene sulfone) can contain at least 5, 10, 20, 30, 40, 50, 60, or 70 mole percent of the —(Ar—SO₂)— unit. In an embodiment, poly(arylene sulfone) can contain up to 50, 70, 80, 90, 95, 99, or 100 mole percent of the —(Ar—SO₂)— unit. In some embodiments, poly(arylene sulfone) can contain from any minimum mole percent of the —(Ar—SO₂)— unit disclosed herein to any maximum mole percent of the —(Ar—SO₂)— unit disclosed herein; for example from 5 to 99 mole percent, 30 to 70 mole percent, or 70 to 95 mole percent of the —(Ar—SO₂)— unit. Poly(arylene sulfone) containing less than 100 percent —(Ar—SO₂)— can further comprise one or more units selected from any poly(arylene sulfide) unit disclosed herein and those having structure

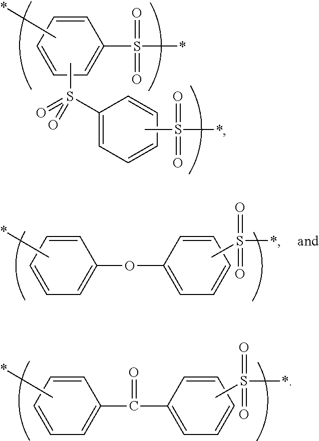

In an embodiment, the substituent(s) of the arylene group of any poly(arylene sulfide) or poly(arylene sulfone) disclosed herein can comprise, or consist of, a C₁ to C₁₀ hydrocarbyl group(s), a C₁ to C₁₀ hydrocarboxy group(s), or a C₁ to C₁₀ hydrocarbylthio group(s); alternatively, a C₁ to C₁₀) hydrocarbyl group(s) or a C₁ to C₁₀ hydrocarboxy group(s); alternatively, a C₁ to C₁₀ hydrocarbyl group(s); or alternatively, a C₁ to C₁₀ hydrocarboxy group(s). In some embodiments, the substituent(s) of the arylene group of any poly(arylene sulfide) or poly(arylene sulfone) disclosed herein can comprise, or consist of, a C₁ to C₁₀ alkyl group(s), a C₁ to C₁₀ alkoxy group(s), or a C₁ to C₁₀ alkylthio group(s); alternatively, a C₁ to C₁₀ alkyl group(s) or a C₁ to C₁₀ alkoxy group; alternatively, a C₁ to C₁₀ alkyl group(s); or alternatively, a C₁ to C₁₀ alkoxy group(s). In other embodiments, the substituent(s) of the arylene group of any poly(arylene sulfide) or poly(arylene sulfone) disclosed herein can comprise, or consist of, a C₁ to C₅ alkyl group(s), a C₁ to C₅ alkoxy group(s), or a C₁ to C₅ alkylthio group(s); alternatively, a C₁ to C₅ alkyl group(s) or a C₁ to C₅ alkoxy group(s); alternatively, a C₁ to C₅ alkyl group(s); or alternatively, a C₁ to C₅ alkoxy group(s). In some embodiments, the substituent(s) of the arylene group of any poly(arylene sulfide) or poly(arylene sulfone) disclosed herein can comprise, or consist of, a methyl group, an ethyl group, a propyl group, a butyl group, a pentyl group, a hexyl group, a heptyl group, and an octyl group, a nonyl group, or a decyl group; alternatively, a methyl group, an ethyl group, a propyl group, a butyl group, or a pentyl group.

Some examples of suitable poly(arylene sulfide) polymers include poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetra-methylphenylene sulfide), poly(butylcyclohexylphenylene sulfide), poly(hexyldodecylphenylene sulfide), poly(octadecylphenylene sulfide), poly(phenyphenylene), poly(tolylphenylene sulfide), poly(benzyl-phenylene sulfide), poly[octyl-4-(3-methylcyclopentyl)phenylene sulfide], and any combination thereof. Some examples of suitable poly(arylene sulfone) polymers include poly(2,4-toluene sulfone), poly(4,4′-biphenylene sulfone), poly(para-phenylene sulfone), poly(ortho-phenylene sulfone), poly(meta-phenylene sulfone), poly(xylene sulfone), poly(ethylisopropylphenylene sulfone), poly(tetramethylphenylene sulfone), poly(butylcyclohexylphenylene sulfone), poly(hexyldodecyl-phenylene sulfone), poly(octadecylphenylene sulfone), poly(phenylphenylene), poly(tolylphenylene sulfone), poly(benzylphenylene sulfone), poly[octyl-4-(3-methylcyclopentyl)phenylene sulfone], and any combination thereof.

Generally, poly(phenylene sulfide) is a polymer comprising at least 70, 80, 90, or 95 mole %, of para-phenylene sulfide units. The structure for the para-phenylene sulfide unit is provided shown below.

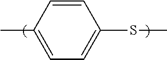

poly(phenylene sulfide) can comprise up to 30, 20, 10, or 5 mole %, of units selected from ortho-phenylene sulfide group, meta-phenylene sulfide groups, substituted phenylene sulfide groups, phenylene sulfone groups, substituted phenylene sulfide groups, and a group having structure

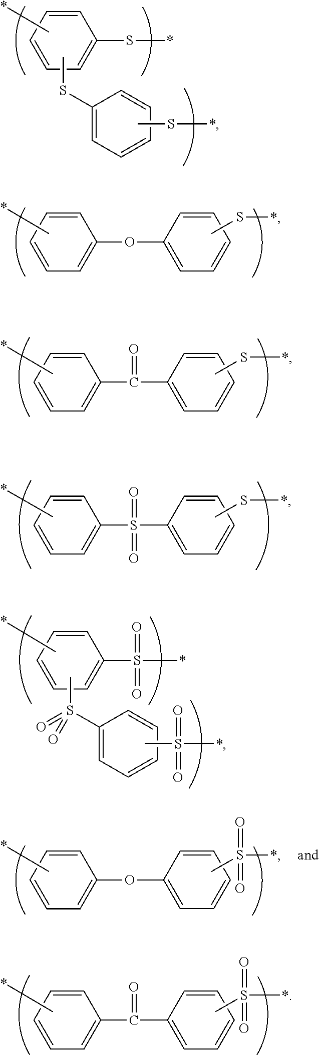

In other embodiments, poly(phenylene sulfide) can comprise up to up to 30, 20, 10, or 5 mole selected from the group having the structures

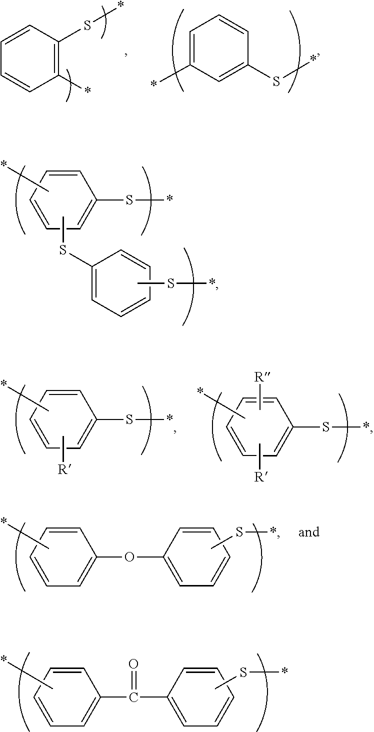

wherein R′ and R″ can be independently selected from any arylene substituent group disclosed herein for a poly(arylene sulfide). In other embodiments, poly(phenylene sulfide) can comprise up to 30, 20, 10, or 5 mole selected from the group having the structures

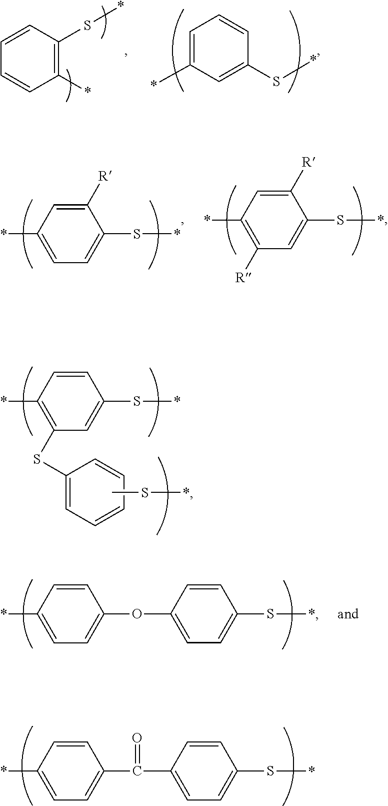

wherein R′ and R″ can be independently selected from any arylene substituent group disclosed herein for a poly(arylene sulfide). In other embodiments, poly(phenylene sulfide) can comprise up to up to 30, 20, 10, or 5 mole selected from the group having the structures

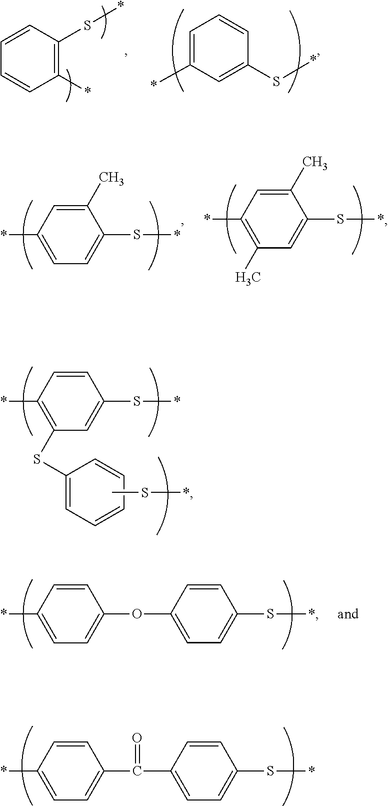

The poly(phenylene sulfide) molecular structure can readily form a thermally stable crystalline lattice, giving poly(phenylene sulfide) a semi-crystalline morphology with a high crystalline melting point ranging from about 265° C. to about 315° C. Because of its molecular structure, poly(phenylene sulfide) also can tend to char during combustion, making the material inherently flame resistant. Further, the material may not typically dissolve in solvents at temperatures below about 200° C.

Poly(phenylene sulfide) is manufactured and sold under the trade name Ryton® PPS by Chevron Phillips Chemical Company LP of The Woodlands, Tex. Other sources of poly(phenylene sulfide) include Ticona, Toray, and Dainippon Ink and Chemicals, Incorporated, among others.

In an aspect the carbamate (general first, second, or other) can have Formula 1 or Formula 2. In another aspect the carbamate (general first, second, or other) can have Formula 1; or alternatively, Formula 2.

R⁴(NHCO₂R³)_{y} Formula 1

Rₓ(R¹O)₃₋ₓSiR²NHCO₂R³ Formula 2

In respect to Formula 1, R³, R⁴, and y are independent elements which are independently described herein and can be utilized in any combination to further describe the carbamate having Formula 1. In respect to Formula 2, R, R¹, R², R³, and x are independent elements which are independently described herein and can be utilized in any combination to further describe the carbamate having Formula 2. It should also be noted that the carbamate having Formula 2 is a subset of the carbamate having Formula 1 where y is 1 and R⁴ is the organyl group Rₓ(R¹O)₃—SiR²—.

In an aspect, y can be any positive integer greater than zero. In an embodiment, y can range from 1 to 6, alternatively, 1 to 4. In some embodiments, y can be 1, 2, or 3; alternatively, 1 or 2; alternatively, 1; alternatively, 2; or alternatively 3.

In an aspect, x can be 0, 1, 2, or 3; or alternatively, 0, 1, or 2. In an embodiment, x can be 0, 1, or 2; alternatively, 0; alternatively, 1; alternatively, 2; or alternatively, 3.

In an aspect, R⁴ can be an organic group; alternatively, a hydrocarbon group or substituted hydrocarbon group; alternatively, a hydrocarbon group; or alternatively, a substituted hydrocarbon group. In some embodiments, R⁴ can be aliphatic or aromatic (independent of whether R⁴ is an organic group, a hydrocarbon group, or a substituted hydrocarbon group); alternatively, aliphatic; or alternatively, aromatic. Regardless of whether R⁴ is an organic group, a hydrocarbon group, or a substituted hydrocarbon group or whether R⁴ is aliphatic or aromatic, R⁴ can be a C₁ to C₈₀ group; alternatively, a C₁ to C₆₀ group; alternatively, C₁ to C₄₀ group; alternatively, C₁ to C₂₀ group; alternatively, a C₁ to C₁₀ group; or alternatively, a C₁ to C₅ group. In an aspect, R³ and R⁴ (when y is 1) of the carbamate having Formula 1 and/or R, R¹, and R³ of the carbamate having Formula 2 independently can be an organyl group; alternatively, a hydrocarbyl group or substituted hydrocarbyl group; alternatively, a hydrocarbyl group; or alternatively, a substituted hydrocarbyl group. In some embodiments, the organyl group or hydrocarbyl group which can be utilized R³ and R⁴ (when y is 1) of the carbamate having Formula 1 and/or R, R¹, and R³ of the carbamate having Formula 2 independently can be aliphatic or aromatic (independent of whether they are an organic group, a hydrocarbon group, or a substituted hydrocarbon group); alternatively, aliphatic; or alternatively, aromatic. Generally, the organyl group (aliphatic or aromatic) or hydrocarbyl group (substituted or unsubstituted, and/or aliphatic or aromatic) which can be utilized as R³ and R⁴ (when y is 1) of the carbamate having Formula 1 and/or R, R¹, and R³ of the carbamate having Formula 2 independently can be a C₁ to C₂₀ group; alternatively, a C₁ to C₁₀ group; or alternatively, a C₁ to C₅ group.

In an embodiment, R³ and R⁴ (when y is 1) of the carbamate having Formula 1 and/or R, R¹, and R³ of the carbamate having Formula 2 independently can be an alkyl group, a substituted alkyl group, a cycloalkyl group, a substituted cycloalkyl group, an aryl group, a substituted aryl group, an aralkyl group, or a substituted aralkyl group; alternatively, alkyl group, a cycloalkyl group, an aryl group, or an aralkyl group; alternatively, an alkyl group or a substituted alkyl group; alternatively, a cycloalkyl group or a substituted cycloalkyl group; alternatively, an aryl group or a substituted aryl group; alternatively, an aralkyl group, or a substituted aralkyl group; alternatively, alternatively, an alkyl group; alternatively, a cycloalkyl group; alternatively, an aryl group; or alternatively, an aralkyl group. Generally, the alkyl groups, substituted alkyl groups, cycloalkyl groups, substituted cycloalkyl groups, aryl groups, a substituted aryl groups, aralkyl groups, and substituted aralkyl groups which can be utilized as R³ and R⁴ (when y is 1) of the carbamate having Formula 1 and/or R, R¹, and R³ of the carbamate having Formula 2 independently can have the same number of carbon atoms as organyl group or hydrocarbyl group of which they are a member.

In an aspect, the alkyl group (substituted or unsubstituted) which can be utilized as R³ and R⁴ (when y is 1) of the carbamate having Formula 1 and/or R, R¹, and R³ of the carbamate having Formula 2 independently can be a C₁-C₂₀ alkyl group (substituted or unsubstituted); alternatively, a C₁-C₁₀ alkyl group (substituted or unsubstituted); or alternatively, a C₁-C₅ alkyl group (substituted or unsubstituted). In some embodiments, each alkyl group (substituted or unsubstituted) which can be utilized as R³ and R⁴ (when y is 1) of the carbamate having Formula 1 and/or R, R¹, and R³ of the carbamate having Formula 2 independently can be a methyl group, an ethyl group, a propyl group, a butyl group, a pentyl group, a hexyl group, a heptyl group, an octyl group, a nonyl group, a decyl group, a undecyl group, a dodecyl group, a tridecyl group, a tetradecyl group, a pentadecyl group, a hexadecyl group, a heptadecyl group, an octadecyl group, or a nonadecyl group; or alternatively, a methyl group, an ethyl group, a propyl group, a butyl group, a pentyl group, a hexyl group, a heptyl group, an octyl group, a nonyl group, or a decyl group. In other embodiments, each alkyl group (substituted or unsubstituted) which can be utilized as R³ and R⁴ (when y is 1) of the carbamate having Formula 1 and/or R, R¹, and R³ of the carbamate having Formula 2 independently can be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group.

In an aspect, the cycloalkyl group (substituted or unsubstituted) which can be utilized as R³ and R⁴ (when y is 1) of the carbamate having Formula 1 and/or R, R¹, and R³ of the carbamate having Formula 2 independently can be a C₃-C₂₀ cycloalkyl group (substituted or unsubstituted); alternatively, a C₃-C₁₅ cycloalkyl group (substituted or unsubstituted); or alternatively, a C₃-C₁₀ cycloalkyl group (substituted or unsubstituted). In an embodiment, each group which can be utilized as R³ and R⁴ (when y is 1) of the carbamate having Formula 1 and/or R, R¹, and R³ of the carbamate having Formula 2 independently can be a cyclopropyl group, a substituted cyclopropyl group, cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group; alternatively, a cyclopentyl group, a substituted cyclopentyl group, a cyclohexyl group, or a substituted cyclohexyl group. In other embodiments, each group which can be utilized as R³ and R⁴ (when y is 1) of the carbamate having Formula 1 and/or R, R¹, and R³ of the carbamate having Formula 2 independently can be cyclopropyl group or a substituted cyclopropyl group; alternatively, a cyclobutyl group or a substituted cyclobutyl group; alternatively, a cyclopentyl group or a substituted cyclopentyl group; alternatively, a cyclohexyl group or a substituted cyclohexyl group; alternatively, a cycloheptyl group or a substituted cycloheptyl group; or alternatively, a cyclooctyl group, or a substituted cyclooctyl group; alternatively, a cyclopentyl group; alternatively, a substituted cyclopentyl group; a cyclohexyl group; or alternatively, a substituted cyclohexyl group.

In an embodiment, the aryl group (substituted or unsubstituted) which can be utilized as R³ and R⁴ (when y is 1) of the carbamate having Formula 1 and/or R, R¹, and R³ of the carbamate having Formula 2 independently can be a C₆-C₂₀ aryl group (substituted or unsubstituted); alternatively, a C₆-C₁₅ aryl group (substituted or unsubstituted); or alternatively, a C₆-C₁₀ aryl group (substituted or unsubstituted). In some embodiments, each group which can be utilized as R³ and R⁴ (when y is 1) of the carbamate having Formula 1 and/or R, R¹, and R³ of the carbamate having Formula 2 independently can be a phenyl group, a substituted phenyl group, a naphthyl group, or a substituted naphthyl group; alternatively, phenyl group or a substituted phenyl group; alternatively, a phenyl group; or alternatively, a substituted phenyl group. In an embodiment, each substituted phenyl group which can be utilized as R³ and R⁴ (when y is 1) of the carbamate having Formula 1 and/or R, R¹, and R³ of the carbamate having Formula 2 independently can be a 2-substituted phenyl group, a 3-substituted phenyl group, a 4-substituted phenyl group, a 2,4-disubstituted phenyl group, a 2,6-disubstituted phenyl group, 3,5-disubstituted phenyl group, a 2,5-disubstituted phenyl group, or a 2,4,6-trisubstituted phenyl group. In other embodiments, each substituted phenyl group which can be utilized as R³ and R⁴ (when y is 1) of the carbamate having Formula 1 and/or R, R¹, and R³ of the carbamate having Formula 2 independently can be a 2-substituted phenyl group, a 4-substituted phenyl group, a 2,4-disubstituted phenyl group, or a 2,6-disubstituted phenyl group; alternatively, a 3-substituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; alternatively, 2,5-disubstituted phenyl group; or alternatively, a 2,4,6-trisubstituted phenyl group.

In an embodiment, each group which can be utilized as R³ and R⁴ (when y is 1) of the carbamate having Formula 1 and/or R, R¹, and R³ of the carbamate having Formula 2 independently can be a phenyl group, a 2-methylphenyl group, a 3-methylphenyl group, a 4-methylphenyl group, a 2,4-dimethylphenyl group, a 2,6-dimethylphenyl group, 3,5-dimethylphenyl group, or a 2,4,6-trimethylphenyl group. In some embodiments, each group which can be utilized as R³ and R⁴ (when y is 1) of the carbamate having Formula 1 and/or R, R¹, and R³ of the carbamate having Formula 2 independently can be a phenyl group, a 2-methylphenyl group, a 4-methylphenyl group, 2,4-dimethylphenyl group, a 2,6-dimethylphenyl group, or a 2,4,6-trimethylphenyl group; alternatively, phenyl group, a 2,4-dimethylphenyl group, a 2,6-dimethylphenyl group, or a 2,4,6-trimethylphenyl group; alternatively, a phenyl group; alternatively, a 2-methylphenyl group; alternatively, a 3-methylphenyl group; alternatively, a 4-methylphenyl group; alternatively, a 2,4-dimethylphenyl group; alternatively, a 2,6-dimethylphenyl group; alternatively, 3,5-dimethylphenyl group; or alternatively, a 2,4,6-trimethylphenyl group.

In some embodiments, the aralkyl group (substituted or unsubstituted) which can be utilized as R³ and R⁴ (when y is 1) of the carbamate having Formula 1 and/or R, R¹, and R³ of the carbamate having Formula 2 independently can be a C₇-C₂₀ aralkyl group (substituted or unsubstituted); alternatively, a C₇-C₁₅ aralkyl group (substituted or unsubstituted); or alternatively, a C₇-C₁₀ aralkyl group (substituted or unsubstituted). In some embodiments, each group which can be utilized as R³ and R⁴ (when y is 1) of the carbamate having Formula 1 and/or R, R¹, and R³ of the carbamate having Formula 2 independently can be a benzyl group or a substituted benzyl group; alternatively, a benzyl group, or alternatively, a substituted benzyl group.

In an embodiment, each group which can be utilized as R³ and R⁴ (when y is 1) of the carbamate having Formula 1 and/or R, R¹, and R³ of the carbamate having Formula 2 independently can be a benzyl group, a methylene(2-methylphenyl) group, a methylene(3-methylphenyl) group, a methylene(4-methylphenyl) group, or a methylene(3,5-dimethylphenyl) group. In an embodiment, each group which can be utilized as R³ and R⁴ (when y is 1) of the carbamate having Formula 1 and/or R, R¹, and R³ of the carbamate having Formula 2 independently can be a benzyl group; alternatively, methylene(2-methylphenyl) group; alternatively, a methylene(3-methylphenyl) group; alternatively, a methylene(4-methylphenyl) group; or alternatively, a methylene(3,5-dimethylphenyl) group.

In an aspect, R⁴ (when y is greater than 1) can be an organic group; alternatively, a hydrocarbon group or a substituted hydrocarbon group; alternatively, a hydrocarbon group; or alternatively, a substituted hydrocarbon group. In some embodiments, the organic group or hydrocarbon group which can be utilized as R⁴ (when y is greater than 1) can be aliphatic or aromatic; alternatively, aliphatic; or alternatively, aromatic. Generally, the organic group (aliphatic or aromatic) or hydrocarbon group (substituted or unsubstituted, and/or aliphatic or aromatic) R⁴ group (when y is greater than 1) can be a C₁ to C₈₀ group; alternatively, a C₁ to C₆₀ group; alternatively, a C₁ to C₄₀ group; alternatively, a C₁ to C₂₀ group; or alternatively, a C₁ to C₁₀ group. Generally, R⁴ will have y undesignated valances.

In an aspect, R⁴ (when y is greater than 1) can be an alkane group, a substituted alkane group, a cycloalkane group, a substituted cycloalkane group, an arene group, a substituted arene group, an aralkane group, or a substituted aralkane group. In an embodiment, R⁴ (when y is greater than 1) can be an alkane group, a cycloalkane group, an arene group, or an aralkane group; alternatively, an alkane group or a substituted alkane group; alternatively, a cycloalkane group or a substituted cycloalkane group; alternatively, an arene group or a substituted arene group; alternatively, an aralkane group or a substituted aralkane group; alternatively, an alkane group; alternatively, a cycloalkane group; alternatively, an arene group; or alternatively, an aralkane group. Generally, the alkane groups, substituted alkane groups, cycloalkane groups, substituted cycloalkane groups, arene groups, a substituted arene groups, aralkane groups, and substituted aralkane groups which can be utilized as R⁴ (when y is greater than 1) of the carbamate having Formula 1 independently can have the same number of carbon atoms as organic group or hydrocarbon group of which they are a member.

In some embodiments, the alkane group (substituted or unsubstituted) which can be utilized as R⁴ (when y is greater than 1) can be a C₁ to C₈₀ alkane group; alternatively, a C₁ to C₆₀ alkane group; alternatively, a C₁ to C₄₀ alkane group; alternatively, a C₁ to C₂₀ alkane group; alternatively, a C₁ to C₁₀ alkane group; alternatively, a C₁ to C₅ alkane group. In other embodiments, the cycloalkane group (substituted or unsubstituted) which can be utilized as R⁴ (when y is greater than 1) can be a C₄ to C₈₀ cycloalkane group; alternatively, a C₄ to C₆₀ cycloalkane group; alternatively, a C₄ to C₄₀ cycloalkane group; alternatively, a C₄ to C₂₀ cycloalkane group; or alternatively, a C₄ to C₁₀ cycloalkane group. In further embodiments, the arene group (substituted or unsubstituted) which can be utilized as R⁴ (when y is greater than 1) can be C₆ to C₈₀ arene group; alternatively, a C₆ to C₆₀ arene group; alternatively, a C₆ to C₄₀ arene group; alternatively, a C₆ to C₂₀ arene group; alternatively, a C₆ to C₁ₛ arene group; or alternatively, a C₆ to C₁₀ arene group. In yet further embodiments, the aralkane group (substituted or unsubstituted) which can be utilized as R⁴ (when y is greater than 1) can be a C₇ to C₈₀ aralkane group; alternatively, a C₇ to C₆₀ aralkane group; alternatively, a C₇ to C₄₀ aralkane group; alternatively, a C₇ to C₂₀ aralkane group; alternatively, a C₇ to C₁₅ aralkane group; alternatively, a C₇ to C₁₀ aralkane group.

In an aspect, R⁴ (when y is 2) of the carbamate having Formula 1 and/or R² of the carbamate having Formula 2 independently can be an organylene group; alternatively, a hydrocarbylene group or substituted hydrocarbylene group; alternatively, a hydrocarbylene group; or alternatively, a substituted hydrocarbylene group. In some embodiments, the organylene group or hydrocarbylene group which can be utilized R⁴ (when y is 2) of the carbamate having Formula 1 and/or R² of the carbamate having Formula 2 independently can be aliphatic or aromatic (regardless of whether R⁴ is an organylene group, hydrocarbylene group, or substituted hydrocarbyl group); alternatively, aliphatic; or alternatively, aromatic. Generally, the organylene group (aliphatic or aromatic) or hydrocarbylene group (substituted or unsubstituted, and/or aliphatic or aromatic) which can be utilized as R⁴ (when y is 2) of the carbamate having Formula 1 and/or R² of the carbamate having Formula 2 independently can be a C₁ to C₄₀ group; alternatively, C₁ to C₂₀ group; alternatively, a C₁ to C₁₀ group; or alternatively, a C₁ to C₅ group.

In an aspect, R⁴ (when y is 2) of the carbamate having Formula 1 and/or R² of the carbamate having Formula 2 independently can be an alkylene group, a substituted alkylene group, a cycloalkylene group, a substituted cycloalkylene group, an arylene group, a substituted arylene group, an aralkylene group, or a substituted aralkylene group; alternatively, alkylene group, a cycloalkylene group, an arylene group, or an aralkylene group. In some embodiments, R⁴ (when y is 2) of the carbamate having Formula 1 and/or R² of the carbamate having Formula 2 independently can be an alkylene group or a substituted alkylene group; alternatively, a cycloalkylene group or a substituted cycloalkylene group; alternatively, an arylene group or a substituted arylene group; alternatively, an aralkylene group, or a substituted aralkylene group; alternatively, an alkylene group; alternatively, a cycloalkylene group; alternatively, an arylene group; or alternatively, an aralkylene group. Generally, the alkylene groups, substituted alkylene groups, cycloalkylene groups, substituted cycloalkylene groups, arylene groups, a substituted arylene groups, aralkylene groups, and substituted aralkylene groups which can be utilized as R⁴ (when y is 2) of the carbamate having Formula 1 can have the same number of carbon atoms as organylene group or hydrocarbylene group of which they are a member.

In an aspect, the alkylene group (substituted or unsubstituted) which can be utilized as R⁴ (when y is 2) of the carbamate having Formula 1 and/or R² of the carbamate having Formula 2 independently can be a C₁ to C₄₀ alkylene group (substituted or unsubstituted); alternatively, a C₁ to C₂₀ alkylene group (substituted or unsubstituted); alternatively, a C₁ to C₁₀ alkylene group (substituted or unsubstituted); or alternatively, a C₁ to C₅ alkylene group (substituted or unsubstituted). In an embodiment, R⁴ (when y is 2) of the carbamate having Formula 1 and/or R² of the carbamate having Formula 2 independently can be a methylene group, an ethylene group, a propylene group, a butylene group, a pentylene group, a hexylene group, a heptylene group, an octylene group, a nonylene group, a decylene group, an undecylene group, a dodecylene group, a tridecylene group, a tetradecylene group, a pentadecylene group, a hexa-decylene group, a heptadecylene group, or an octadecylene group; alternatively, a methylene group, an ethylene group, a propylene group, a butylene group, a pentylene group, a hexylene group, a heptylene group, an octylene group, a nonylene group, or a decylene group. In some embodiments, R² and/or R⁴ (when y is 2) independently can be a methylene group, an eth-1,2-ylene group, a prop-1,2-ylene group, a prop-1,3-ylene group, a but-1,2-ylene group, a but-2,3-ylene group, a but-1,4-ylene group, a 2-methylprop-1,2-ylene group, a pent-1,5-ylene group, a pent-1,4-ylene group, a pent-1,3-ylene group, a pent-2,4-ylene group, a 2,2-dimethylprop-1,3-ylene group, a hex-1,6-ylene group, a 2-methypent-1,5-ylene group, a 2,3-dimethylbut-1,4-ylene group a 2,3-dimethylbut-2,3-ylene group, a 1,7-heptylene group, a 2,2′-dimethylpent-1,5-ylene group, an oct-1,8-ylene group, a non-1,9-ylene group, a 2,2,4-trimethylhex-1,6-ylene group, a 2,4,4-trimethylhex-1,6-ylene group, a dec-1,10-ylene group, an undec-1,1′-ylene group, a 2-butyl-2-ethylpent-1,5-ylene group, or a dodec-1,12-ylene group; or alternatively, an eth-1,2-ylene group, a prop-1,3-ylene group, a but-1,2-ylene group, a but-1,4-ylene group, a hex-1,6-ylene group, an oct-1,8-ylene group, a dec-1,10-ylene group, or a dodec-1,12-ylene group; alternatively, a methylene group; alternatively, an eth-1,2-ylene group; alternatively, a prop-1,2-ylene group; alternatively, a prop-1,3-ylene group; alternatively, a but-1,2-ylene group; alternatively, a but-2,3-ylene group; alternatively, a but-1,4-ylene group; alternatively, a 2-methylprop-1,2-ylene group; alternatively, a pent-1,5-ylene group; alternatively, a pent-1,4-ylene group; alternatively, a pent-1,3-ylene group; alternatively, a pent-2,4-ylene group; alternatively, a 2,2-dimethylprop-1,3-ylene group; alternatively, a hex-1,6-ylene group; alternatively, an oct-1,8-ylene group; alternatively, a dec-1,10-ylene group; or alternatively, a dodec-1,12-ylene group.

In an aspect, R⁴ (when y is 2) of the carbamate having Formula 1 and/or R² of the carbamate having Formula 2 independently can have the Formula —(CR′₂)ₙ—. Generally, R′ and n are independent elements the R⁴ (when y is 2) of the carbamate having Formula 1 and/or R² of the carbamate having Formula 2 having the Formula —(CR′₂)ₙ—. R′ and n are independently described herein and can be utilized in any combination to further describe R⁴ (when y is 2) of the carbamate having Formula 1 and/or R² of the carbamate having Formula 2 having the Formula —(CR′₂)ₙ—. In an embodiment, n can be an integer ranging from 1 to 20; alternatively, an integer ranging from 1 to 10; or alternatively, an integer ranging from 1 to 5. In some embodiments, n can be 1; alternatively, 2; alternatively, 3; alternatively, 4; alternatively, 5; or alternatively, 6. In an embodiment, each R′ can independently be hydrogen or a C₁ to C₅ alkyl group. Alkyl substituents groups are described herein and can be utilized without limitation to further describe R⁴ (when y is 2) of the carbamate having Formula 1 and/or R² of the carbamate having Formula 2 having the Formula —(CR'₂)ₙ—.

In an aspect, the cycloalkylene group (substituted or unsubstituted) which can be utilized as R⁴ (when y is 2) of the carbamate having Formula 1 and/or R² of the carbamate having Formula 2 independently can be a C₃-C₄₀ cycloalkyl group (substituted or unsubstituted); alternatively, a C₃-C₂₀ cycloalkyl group (substituted or unsubstituted); alternatively, a C₃-C₁₅ cycloalkyl group (substituted or unsubstituted); or alternatively, a C₃-C₁₀ cycloalkyl group (substituted or unsubstituted). In an aspect, R⁴ (when y is 2) of the carbamate having Formula 1 and/or R² of the carbamate having Formula 2 independently can be a cyclopropylene group, a substituted cyclopropylene group, a cyclobutylene group, a substituted cyclobutylene group, a cyclopentylene group, a substituted cyclopentylene group, a cyclohexylene group, a substituted cyclohexylene group, a cycloheptylene group, a substituted cycloheptylene group, a cyclooctylene group, or a substituted cyclooctylene group; or alternatively, a cyclopentylene group, a substituted cyclopentylene group, a cyclohexylene group, or a substituted cyclohexylene group. In an embodiment, R⁴ (when y is 2) of the carbamate having Formula 1 and/or R² of the carbamate having Formula 2 independently can be a cyclopropylene group or a substituted cyclopropylene group; alternatively, cyclobutylene group or a substituted cyclobutylene group; alternatively, a cyclopentylene group or a substituted cyclopentylene group; alternatively, a cyclohexylene group or a substituted cyclohexylene group; alternatively, a cycloheptylene group or a substituted cycloheptylene group; or alternatively, a cyclooctylene group, or a substituted cyclooctylene group; alternatively, a cyclopentylene group; alternatively, a substituted cyclopentylene group; a cyclohexylene group; or alternatively, a substituted cyclohexylene group.

In an aspect, R⁴ (when y is 2) of the carbamate having Formula 1 and/or R² of the carbamate having Formula 2 independently can be a cyclopent-1,2-ylene group, a substituted cyclopent-1,2-ylene group, a cyclopent-1,3-ylene group, a substituted cyclopent-1,3-ylene group, a cyclohex-1,2-ylene group, a substituted cyclohex-1,2-ylene group, a cyclohex-1,3-ylene group, a substituted cyclohex-1,3-ylene group, a cyclohex-1,4-ylene group, or a substituted cyclohex-1,4-ylene group; alternatively, a cyclopent-1,2-ylene group, a substituted cyclopent-1,2-ylene group, a cyclopent-1,3-ylene group, or a substituted cyclopent-1,3-ylene group; alternatively, a cyclohex-1,2-ylene group, a substituted cyclohex-1,2-ylene group, a cyclohex-1,3-ylene group, a substituted cyclohex-1,3-ylene group, a cyclohex-1,4-ylene group, or a substituted cyclohex-1,4-ylene group; alternatively, a cyclopent-1,3-ylene group, or a substituted cyclopent-1,3-ylene group; alternatively, a cyclohex-1,3-ylene group, a substituted cyclohex-1,3-ylene group, a cyclohex-1,4-ylene group, or a substituted cyclohex-1,4-ylene group; alternatively, a cyclopent-1,3-ylene group, a cyclohex-1,3-ylene group, or a cyclohex-1,4-ylene group; alternatively, a cyclopent-1,3-ylene group; alternatively, a cyclohex-1,3-ylene group; or alternatively, a cyclohex-1,4-ylene group. In an embodiment, the substituted cyclopent-1,2-ylene group which can be utilized as R⁴ (when y is 2) of the carbamate having Formula 1 and/or R² of the carbamate having Formula 2 can be a 1-substituted, 3-substituted, 4-substituted, or 3,5-disubstituted cyclopent-1,2-ylene group; alternatively, a 3-substituted or 4-substituted cyclopent-1,2-ylene group; alternatively, a 1-substituted cyclopent-1,2-ylene group; alternatively, a 3-substituted cyclopent-1,2-ylene group; alternatively, a 4-substituted cyclopent-1,2-ylene group; or alternatively, a 3,5-disubstituted cyclopent-1,2-ylene group. In an embodiment, the substituted cyclopent-1,3-ylene group can be a 2-substituted, 4-substituted, 2,4-disubstituted, 2,4,5-trisubstituted cyclopent-1,3-ylene group; alternatively, a 2-substituted or 4-substituted cyclopent-1,3-ylene group; alternatively, a 2-substituted cyclopent-1,3-ylene group; alternatively, a 4-substituted cyclopent-1,3-ylene group; alternatively, a 2,4-disubstituted cyclopent-1,3-ylene group; or alternatively, a 2,4,5-trisubstituted cyclopent-1,3-ylene group. In an embodiment, the substituted cyclohex-1,2-ylene group which can be utilized as R² and/or R⁴ (when y is 2) can be a 3-substituted, 4-substituted, 3,4-disubstituted, 3,5-disubstituted, or 3,6-disubstituted cyclohex-1,2-ylene group; alternatively, a 3-substituted or 4-substituted cyclohex-1,2-ylene group; alternatively, a 3,4-disubstituted, 3,5-disubstituted, or 3,6-disubstituted cyclohex-1,2-ylene group; alternatively, a 3-substituted cyclohex-1,2-ylene group; alternatively, a 4-substituted cyclohex-1,2-ylene group; alternatively, a 3,4-disubstituted cyclohex-1,2-ylene group; alternatively, a 3,5-disubstituted cyclohex-1,2-ylene group; or alternatively, a 3,6-disubstituted cyclohex-1,2-ylene group. In an embodiment, the substituted cyclohex-1,3-ylene group can be a 2-substituted, 4-substituted, a 5-substituted, 2,4-disubstituted, 2,5-disubstituted, 4,6-disubstituted, or 2,4,6-trisubstituted cyclohex-1,3-ylene group; alternatively, a 2-substituted, 4-substituted, or 5-substituted cyclohex-1,3-ylene group; alternatively, a 2,4-disubstituted, 2,5-disubstituted, 4,6-disubstituted cyclohex-1,3-ylene group; alternatively, a 2-substituted cyclohex-1,3-ylene group; alternatively, a 4-substituted cyclohex-1,3-ylene group; alternatively, a 5-substituted cyclohex-1,3-ylene group; alternatively, a 2,4-disubstituted cyclohex-1,3-ylene group; alternatively, a 2,5-disubstituted cyclohex-1,3-ylene group; alternatively, a 4,6-disubstituted cyclohex-1,3-ylene group; or alternatively, a 2,4,6-trisubstituted cyclohex-1,3-ylene group. In an embodiment, the substituted cyclohex-1,4-ylene group can be a 2-substituted, 2,3-disubstituted, 2,5-disubstituted, 2,6-disubstituted, 2,3,5-triisubstituted, or 2,3,5,6-tetrasubstituted cyclohex-1,4-ylene group; alternatively, a 2,3-disubstituted, 2,5-substituted, or 2,6-disubstituted cyclohex-1,4-ylene group; alternatively, a 2-substituted cyclohex-1,4-ylene group; alternatively, a 2,3-disubstituted cyclohex-1,4-ylene group; alternatively, a 2,5-disubstituted cyclohex-1,4-ylene group; alternatively, a 2,6-disubstituted cyclohex-1,4-ylene group; alternatively, a 2,3,5-triisubstituted cyclohex-1,4-ylene group; or alternatively, a 2,3,5,6-tetrasubstituted cyclohex-1,4-ylene group.

In an aspect, R⁴ (when y is 2) of the carbamate having Formula 1 and/or R² of the carbamate having Formula 2 independently can be a dimethylenecyclopentane group, a substituted dimethylenecyclopentane group, a dimethylenecyclohexane group, or a substituted dimethylenecyclohexane group; alternatively, a dimethylenecyclopentane group or a substituted dimethylenecyclopentane group; alternatively, a dimethylenecyclohexane group or a substituted dimethylenecyclohexane group; alternatively, a dimethylenecyclopentane group; or alternatively, a dimethylenecyclohexane group. In an embodiment, R² and/or R⁴ (when y is 2) independently can be a 1,3-dimethylenecyclopentane group, a substituted 1,3-dimethylenecyclopentane group, a 1,3-dimethylenecyclohexane group, a substituted 1,3-dimethylenecyclohexane group, a 1,4-dimethylenecyclohexane group, or a substituted 1,4-dimethylenecyclohexane group; alternatively, 1,3-dimethylenecyclopentane group, a 1,3-dimethylenecyclohexane group, or a 1,4-dimethylenecyclohexane group. In some embodiments, R⁴ (when y is 2) of the carbamate having Formula 1 and/or R² of the carbamate having Formula 2 independently can be a 1,3-dimethylenecyclopentane group or a substituted 1,3-dimethylenecyclopentane group; alternatively, a 1,3-dimethylenecyclohexane group, a substituted 1,3-dimethylenecyclohexane group, a 1,4-dimethylenecyclohexane group, or a substituted 1,4-dimethylenecyclohexane group; alternatively, a 1,3-dimethylenecyclohexane group or a substituted 1,3-dimethylenecyclohexane group; or alternatively, a 1,4-dimethylenecyclohexane group or a substituted 1,4-dimethylenecyclohexane group. In other embodiments, R⁴ (when y is 2) of the carbamate having Formula 1 and/or R² of the carbamate having Formula 2 independently can be a 1,3-dimethylenecyclopentane group, a 1,3-dimethylenecyclohexane group, or a 1,4-dimethylenecyclohexane group; alternatively, 1,3-dimethylenecyclopentane group; alternatively, a 1,3-dimethylenecyclohexane group; or alternatively, a 1,4-dimethylenecyclohexane group.

In an aspect, R⁴ (when y is 2) of the carbamate having Formula 1 and/or R² of the carbamate having Formula 2 independently can be a bicyclohexylene group, a substituted bicyclohexylene group, a bis(cyclohexylene)methane group, a substituted bis(cyclohexylene)methane group, a bis(cyclohexylene)-ethane group, a substituted bis(cyclohexylene)ethane group; alternatively, a bicyclohexylene group or a substituted bicyclohexylene group; alternatively, a bis(cyclohexylene)methane group or a substituted bis(cyclohexylene)methane group; alternatively, a bis(cyclohexylene)ethane group or a substituted bis(cyclohexylene)ethane group; alternatively, a bis(cyclohexylene) group, bis(cyclohexylene)methane group, or a bis(cyclohexylene)ethane group; alternatively, bis(cyclohexylene) group; alternatively, a bis-(cyclohexylene)methane group; or alternatively, a bis(cyclohexylene)methane group. In an embodiment, R⁴ (when y is 2) of the carbamate having Formula 1 and/or R² of the carbamate having Formula 2 independently can be a bicyclohex-3-ylene group, a substituted bicyclohex-3-ylene group, a bicyclohex-4-ylene group, or a substituted bicyclohex-4-ylene group; alternatively, a bicyclohex-3-ylene group or a substituted bicyclohex-3-ylene group; alternatively, a bicyclohex-4-ylene group, or a substituted the bicyclohex-4-ylene group; alternatively, a bicyclohex-3-ylene group or a bicyclohex-4-ylene group; alternatively, a bicyclohex-3-ylene group; or alternatively, a bicyclohex-4-ylene group. In some embodiments, R⁴ (when y is 2) of the carbamate having Formula 1 and/or R² of the carbamate having Formula 2 independently can be a bis(cyclohex-3-ylene)methane group, a substituted bis(cyclohex-3-ylene)methane group, a bis(cyclohex-4-ylene)methane group, or a substituted bis(cyclohex-4-ylene)-methane group; alternatively, a bis(cyclohex-3-ylene)methane group or a substituted bis(cyclohex-3-ylene)methane group; alternatively, a bis(cyclohex-4-ylene)methane group, or a substituted the bis(cyclohex-4-ylene)methane group; alternatively, a bis(cyclohex-3-ylene)methane group or a bis(cyclohex-4-ylene)methane group; alternatively, a bis(cyclohex-3-ylene)methane group; or alternatively, a bis(cyclohex-4-ylene)methane group. In other embodiments, R⁴ (when y is 2) of the carbamate having Formula 1 and/or R² of the carbamate having Formula 2 independently can be a bis(cyclohex-3-ylene)ethane group, a substituted bis(cyclohex-3-ylene)ethane group, a bi(cyclohex-4-ylene)ethane group, or a substituted bis(cyclohex-4-ylene)ethane group; alternatively, a bis(cyclohex-3-ylene)ethane group or a substituted bis(cyclohex-3-ylene)ethane group; alternatively, a bis(cyclohex-4-ylene)ethane group, or a substituted the bis(cyclohex-4-ylene)ethane group; alternatively, a bis(cyclohex-3-ylene)ethane group or a bis(cyclohex-4-ylene)ethane group; alternatively, a bis(cyclo-hex-3-ylene)ethane group; or alternatively, a bis(cyclohex-4-ylene)ethane group. Generally, any bis(cyclohexylene)ethane group disclosed herein (substituted or unsubstituted) can be a bis-1,1-(cyclo-hexylene)ethane group or a bis-1,2-(cyclohexylene)ethane group; alternatively, a bis-1,1-(cyclo-hexylene)ethane group; or alternatively, a bis-1,2-(cyclohexylene)ethane group.

In an embodiment, the arylene group (substituted or unsubstituted) which can be utilized as R⁴ (when y is 2) of the carbamate having Formula 1 and/or R² of the carbamate having Formula 2 independently can be a C₆-C₄₀ arylene group (substituted or unsubstituted); alternatively, a C₆-C₂₀ arylene group (substituted or unsubstituted); alternatively, a C₆-C₁₅ arylene group (substituted or unsubstituted); or alternatively, a C₆-C₁₀ arylene group (substituted or unsubstituted). In other embodiments, R⁴ (when y is 2) of the carbamate having Formula 1 and/or R² of the carbamate having Formula 2 independently can be a phenylene group, a substituted phenylene group, a naphthylene group, or a substituted naphthylene group; alternatively, a phenylene group or a substituted phenylene group; alternatively, a naphthylene group or a substituted naphthylene group; alternatively a phenylene group or a naphthylene; alternatively a phenylene group; or alternatively, a naphthylene group. In an embodiment, R⁴ (when y is 2) of the carbamate having Formula 1 and/or R² of the carbamate having Formula 2 independently can be a phen-1,2-ylene group, a substituted phen-1,2-ylene group, a phen-1,3-ylene group, a substituted phen-1,3-ylene group, a phen-1,4-ylene group, or a substituted phen-1,4-ylene group; alternatively, a alternatively, a phen-1,2-ylene group or a substituted phen-1,2-ylene group; alternatively, a phen-1,3-ylene group or a substituted phen-1,3-ylene group; alternatively, a phen-1,4-ylene group or a substituted phen-1,4-ylene group; alternatively, a phen-1,2-ylene group, a phen-1,3-ylene group, or a phen-1,4-ylene group; alternatively, a phen-1,2-ylene group; alternatively, a phen-1,3-ylene group; or alternatively, a phen-1,4-ylene group. In an embodiment, the substituted phen-1,2-ylene group can be a 3-substituted, 4-substituted, 3,4-disubstituted, 3,5-disubstituted, or 3,6-disubstituted phen-1,2-ylene group; alternatively, a 3-substituted or 4-substituted phen-1,2-ylene group; alternatively, a 3,4-disubstituted, 3,5-disubstituted, or 3,6-disubstituted phen-1,2-ylene group; alternatively, a 3-substituted phen-1,2-ylene group; alternatively, a 4-substituted phen-1,2-ylene group; alternatively, a 3,4-disubstituted phen-1,2-ylene group; alternatively, a 3,5-disubstituted phen-1,2-ylene group; or alternatively, a 3,6-disubstituted phen-1,2-ylene group. In an embodiment, the substituted phen-1,3-ylene group which can be utilized as R⁴ (when y is 2) of the carbamate having Formula 1 and/or R² of the carbamate having Formula 2 independently can be a 2-substituted, 4-substituted, a 5-substituted, 2,4-disubstituted, 2,5-disubstituted, 4,6-disubstituted, or 2,4,6-trisubstituted phen-1,3-ylene group; alternatively, a 2-substituted, 4-substituted, or 5-substituted phen-1,3-ylene group; alternatively, a 2,4-disubstituted, 2,5-disubstituted, 4,6-disubstituted phen-1,3-ylene group; alternatively, a 2-substituted phen-1,3-ylene group; alternatively, a 4-substituted phen-1,3-ylene group; alternatively, a 5-substituted phen-1,3-ylene group; alternatively, a 2,4-disubstituted phen-1,3-ylene group; alternatively, a 2,5-disubstituted phen-1,3-ylene group; alternatively, a 4,6-disubstituted phen-1,3-ylene group; or alternatively, a 2,4,6-trisubstituted phen-1,3-ylene group. In an embodiment, the substituted phen-1,4-ylene group which can be utilized as R⁴ (when y is 2) of the carbamate having Formula 1 and/or R² of the carbamate having Formula 2 independently can be a 2-substituted, 2,3-disubstituted, 2,5-disubstituted, 2,6-disubstituted, 2,3,5-triisubstituted, or 2,3,5,6-tetrasubstituted phen-1,4-ylene group; alternatively, a 2,3-disubstituted, 2,5-substituted, or 2,6-disubstituted phen-1,4-ylene group; alternatively, a 2-substituted phen-1,4-ylene group; alternatively, a 2,3-disubstituted phen-1,4-ylene group; alternatively, a 2,5-disubstituted phen-1,4-ylene group; alternatively, a 2,6-disubstituted phen-1,4-ylene group; alternatively, a 2,3,5-trisubstituted phen-1,4-ylene group; or alternatively, a 2,3,5,6-tetrasubstituted phen-1,4-ylene group.

In an aspect, R⁴ (when y is 2) of the carbamate having Formula 1 and/or R² of the carbamate having Formula 2 independently can be a dimethylenebenzene group, or a substituted dimethylene-benzene group; or alternatively, a dimethylenebenzene group. In an embodiment, R² and/or R⁴ (when y is 2) independently can be a 1,3-dimethylenebenzene group, a substituted 1,3-dimethylenebenzene group, a 1,4-dimethylenebenzene group, or a substituted 1,4-dimethylenebenzene group; alternatively, a 1,3-dimethylenebenzene group or a substituted 1,3-dimethylenebenzene group; or alternatively, a 1,4-dimethylenebenzene group or a substituted 1,4-dimethylenebenzene group. In some embodiments, R⁴ (when y is 2) of the carbamate having Formula 1 and/or R² of the carbamate having Formula 2 independently can be can be a 1,3-dimethylenebenzene group or a 1,4-dimethylenebenzene group; alternatively, a 1,3-dimethylenebenzene group; or alternatively, a 1,4-dimethylenebenzene group.

In an aspect, R⁴ (when y is 2) of the carbamate having Formula 1 and/or R² of the carbamate having Formula 2 independently can be a biphenylene group, a substituted biphenylene group, a bis(phenylene)methane group, a substituted bis(phenylene)methane group, a bis(phenylene)ethane group, or a substituted bis(phenylene)ethane group; alternatively, a biphenylene group or a substituted biphenylene group; alternatively, a bis(phenylene)methane group, or substituted bis(phenylene)methane group; alternatively, a bis(phenylene)ethane group or a substituted bis(phenylene)ethane group; alternatively, a biphenylene group, a bis(phenylene)methane group, or a bis(phenylene)ethane group; alternatively, a biphenylene group; alternatively, a bis(phenylene)methane group; or alternatively, a bis(phenylene)ethane group. In an embodiment, R⁴ (when y is 2) of the carbamate having Formula 1 and/or R² of the carbamate having Formula 2 independently can be a biphen-3-ylene group, a substituted biphen-3-ylene group, a biphen-4-ylene group, or a substituted biphen-4-ylene group; alternatively, a biphen-3-ylene group or a substituted biphen-3-ylene group; or alternatively, a biphen-4-ylene group or a substituted biphen-4-ylene group; alternatively, a biphen-3-ylene group or a biphen-4-ylene group; alternatively, a biphen-3-ylene group; or alternatively, biphen-4-ylene group. In some embodiments, R⁴ (when y is 2) of the carbamate having Formula 1 and/or R² of the carbamate having Formula 2 independently can be a bis(phen-3-ylene)methane group, a substituted bis(phen-3-ylene)methane group, a bis(phen-4-ylene)methane group, or a substituted bis(phen-4-ylene)methane group; alternatively, a bis(phen-3-ylene)methane group or a substituted bis(phen-3-ylene)methane group; or alternatively, a bis(phen-4-ylene)methane group or a substituted bis(phen-4-ylene)methane group; alternatively, a bis(phen-3-ylene)methane group or bis(phen-4-ylene)methane group; alternatively, a bis(phen-3-ylene)methane group; or alternatively, bis(phen-4-ylene)methane group. In other embodiments, R⁴ (when y is 2) of the carbamate having Formula 1 and/or R² of the carbamate having Formula 2 independently can be a bis(phen-3-ylene)ethane group, a substituted bis(phen-3-ylene)ethane group, a bis(phen-4-ylene)ethane group, or a substituted bis(phen-4-ylene)ethane group; alternatively, a bis(phen-3-ylene)ethane group or a substituted bis(phen-3-ylene)ethane group; or alternatively, a bis(phen-4-ylene)ethane group or a substituted bis(phen-4-ylene)ethane group; alternatively, a bis(phen-3-ylene)ethane group or bis(phen-4-ylene)ethane group; alternatively, a bis(phen-3-ylene)ethane group; or alternatively, bis(phen-4-ylene)ethane group. Generally, any bis(phenylene)ethane group disclosed herein (substituted or unsubstituted) can be a bis-1,1-(phenylene)ethane group or a bis-1,2-(phenylene)ethane group; alternatively, a bis-1,1-(phenylene)ethane group; or alternatively, a bis-1,2-(phenylene)ethane group.

In an aspect, R⁴ (when y is 3) can be an organic group; alternatively, a hydrocarbon group or substituted hydrocarbon group; alternatively, a hydrocarbon group; or alternatively, a substituted hydrocarbon group. In an embodiment, the organic group or hydrocarbon group which can be utilized R⁴ (when y is 3) can be aliphatic or aromatic; alternatively, aliphatic; or alternatively, aromatic. Generally, the organic group (aliphatic or aromatic) or hydrocarbon group (substituted or unsubstituted, and/or aliphatic or aromatic) R⁴ (when y is 3) can be a C₁ to C₄₀ group; alternatively, a C₁ to C₂₀ group; alternatively, a C₁ to C₁₀ group; or alternatively, a C₁ to Cₛ group.

In an aspect, R⁴ (when y is 3) can be an alkane group, a substituted alkane group, a cycloalkane group, a substituted cycloalkane group, an arene group, a substituted arene group, an aralkane group, or a substituted aralkane group; alternatively, alkane group, a cycloalkane group, an arene group, or an aralkane group. In an embodiment, R⁴ (when y is 3) can be an alkane group or a substituted alkane group; alternatively, a cycloalkane group or a substituted cycloalkane group; alternatively, an arene group or a substituted arene group; alternatively, an aralkane group, or a substituted aralkane group; alternatively, an alkane group; alternatively, a cycloalkane group; alternatively, an arene group; or alternatively, an aralkane group. Generally, the alkane groups, substituted alkane groups, cycloalkane groups, substituted cycloalkane groups, arene groups, a substituted arene groups, aralkane groups, and substituted aralkane groups which can be utilized as R⁴ (when y is 3) of the carbamate having Formula 1 independently can have the same number of carbon atoms as organic group or hydrocarbon group of which they are a member.

In an aspect, the alkane group (substituted or unsubstituted) which can be utilized as R⁴ (when y is 3) independently a C₁ to C₄₀ alkane group; alternatively, a C₁ to C₂₀ alkane group; alternatively, a C₁ to C₁₀ alkane group; or alternatively, a C₁ to C₅ alkane group. In an embodiment, R⁴ (when y is 3) can be a 1,3,6-hexane group, a 1,6,11-undecane group, a 4-methylene-1,8-octylene group, or a 2,5,7-trimethyl-5-methylene-1,8-octylene group; alternatively, a 1,3,6-hexane group or a 1,6,11-undecane group; alternatively, a 1,3,6-hexane group; alternatively, a 1,6,11-undecane group; alternatively, a 4-methylene-1,8-octylene group; or alternatively, a 2,5,7-trimethyl-5-methylene-1,8-octylene group. In some embodiments, any of the R⁴ (when y is 3) alkane groups can be substituted. In an embodiment, R⁴ (when y is 3) can be a 1,3,5-benzene group or a substituted 1,3,5-benzene group; or alternatively, a 1,3,5-benzene group. In some embodiments, the substituted 1,3,5-benzene group can be a 1-methyl-2,4,6-benzene group or a 1,3,5-trimethyl-2,4,6-benzene group; alternatively, a 1-methyl-2,4,6-benzene group; or alternatively, a 1,3,5-trimethyl-2,4,6-benzene group. In an embodiment, R⁴ (when y is 3) can be a 1,3,5-trimethylene benzene group or a substituted 1,3,5-trimethylene benzene group; or alternatively, a 1,3,5-trimethylene benzene group. In an embodiment, R⁴ (when y is 3) can be a 2,4,4′-biphenyl group, a substituted a 2,4,4′-biphenyl group, a 2,4,4′-diphenylmethane group, a substituted 2,4,4′-bis(phenyl)methane group, a 2,4,4′-bis(phenyl)ethane group, a substituted 2,4,4′-bis(phenyl)ethane group; alternatively, a 2,4,4′-biphenyl group or a substituted a 2,4,4′-biphenyl group; alternatively, a 2,4,4′-bis(phenyl)methane group or a substituted 2,4,4′-bis(phenyl)methane group; alternatively, a 2,4,4′-bis(phenyl)ethane group or a substituted 2,4,4′-bis(phenyl)ethane group; alternatively, a 2,4,4′-biphenyl group, a 2,4,4′-bis(phenyl)methane group, or a 2,4,4′-bis(phenyl)ethane group; alternatively, a 2,4,4′-biphenyl group; alternatively, a 2,4,4′-bis(phenyl)methane group; or alternatively, a 2,4,4′-bis(phenyl)ethane group. In an embodiment, R⁴ (when y is 3) can be a tris(phen-4-ylene)methane group or a substituted tris(phen-4-ylene)methane group; or alternatively, a tris(phen-4-ylene)methane group.

Various aspects and embodiments for R, R¹, R², R³, and/or R⁴ can call for substituents. Substituents are independently described herein and these substituents can be utilized, without limitation, to further describe any general or specific substituted R, R¹, R², R³, and/or R⁴ group described herein.

In a non-limiting embodiment, the carbamate having Formula 2 can be, comprise, or consist essentially of, methyl-N-3-(trimethoxysilyl)propylcarbamate, ethyl-N-3-(triethoxysilyl)propylcarbamate, methyl N-3-(triethoxysilyl)propylcarbamate, methyl-N-3-(methyldimethoxysilyl)propylcarbamate, ethyl-N-3-(methyldiethoxysilyl)propylcarbamate, or any combination thereof. In some non-limiting embodiments, the carbamate having Formula 2 can be, comprise, or consist essentially of, methyl-N-3-(trimethoxysilyl)propylcarbamate, ethyl-N-3-(triethoxysilyl)propylcarbamate, methyl-N-3-(triethoxy-silyl)propylcarbamate, or any combination thereof; alternatively, methyl-N-3-(methyldimethoxysilyl)-propylcarbamate, ethyl-N-3-(methyldiethoxysilyl)propylcarbamate, or any combination thereof. In other non-limiting embodiments, the carbamate having Formula 2 can be, comprise, or consist essentially of, methyl-N-3-(trimethoxysilyl)propylcarbamate; alternatively, ethyl-N-3-(triethoxysilyl)propylcarbamate; alternatively, methyl-N-3-(triethoxysilyl)propylcarbamate; alternatively, methyl-N-3-(methyldimethoxy-silyl)propylcarbamate; or alternatively, ethyl-N-3-(methyldiethoxysilyl)propylcarbamate.

In an aspect the compositions described herein, mixtures (first, second, or other) described herein, and/or polymer compositions (first, second or other) described herein can further comprise one or more additives. In an embodiment, the additive(s) can be selected from the group consisting of fire retardants, stabilizers, ultraviolet absorbers, lubricants, pigments, and fillers. In some embodiments, any composition described herein, mixture (first, second, or other) described herein, and/or polymer composition (first second or other) described herein can further comprise a fire retardant; alternatively, an ultraviolet absorber; alternatively, a lubricant; alternatively, a pigment; or alternatively, filler.

In an embodiment, the fire retardant can be a phosphorus based fire retardant, a halogen based fire retardant, a boron based fire retardant, an antimony based fire retardant, an amide based fire retardant, or any combination thereof. In some embodiments, any composition described herein, mixture (first, second, or other) described herein, and/or polymer composition (first second or other) described herein can further comprise a phosphorus based fire retardant; alternatively, a halogen based fire retardant; alternatively, a boron based fire retardant; alternatively, an antimony based fire retardant; or alternatively, an amide based fire retardant. In an embodiment, phosphorus based fire retardants which can be utilized include, but are not limited to, triphenyl phosphate, tricresyl phosphate, a phosphate obtained from a mixture of isopropylphenol and phenol and phosphorus oxychloride, or phosphate esters obtained from difunctional phenols (e.g. benzohydroquinone or bisphenol A), an alcohol, or a phenol and phosphorus oxychloride; alternatively, triphenyl phosphate; alternatively, tricresyl phosphate; alternatively, a phosphate obtained from a mixture of isopropylphenol and phenol and phosphorus oxychloride; or alternatively, phosphate esters obtained from difunctional phenols (e.g. benzohydroquinone or bisphenol A), an alcohol, or a phenol and phosphorus oxychloride. In an embodiment, halogen based fire retardants which can be utilized include, but are not limited to, brominated compounds. In some embodiments, the halogen based fire retardants which can be utilized include, but are not limited to, decabromobiphenyl, pentabromotoluene, decabromobiphenyl ether, hexabromobenzene, or brominated polystyrene. In an embodiment, stabilizers which can be utilized include, but are not limited to, sterically hindered phenols and phosphite compounds. In an embodiment, ultraviolet absorbers which can be utilized include, but are not limited to, oxalic acid diamide compounds or sterically hindered amine compounds. In an embodiment, lubricants which can be utilized include, but are not limited to, polyethylene waxes, polypropylene waxes, and paraffins. In an embodiment, pigments which can be utilized include, but are not limited to, titanium dioxide, zinc sulfide, or zinc oxide.

In an embodiment, fillers which can be utilized include, but are not limited to, a mineral filler, an inorganic filler, or an organic filler. In some embodiments, the filler can comprise, or consist essentially of, a mineral filler; alternatively, an inorganic filler; or alternatively, an organic filler. In an embodiment, mineral fillers which can be utilized include, but are not limited to, glass fibers, milled fibers, glass beads, asbestos, wollastonite, fiberglass, mica, talc, clay, calcium carbonate, magnesium hydroxide, silica, potassium titanate fibers, rockwool, or any combination thereof; alternatively, glass fibers; alternatively, glass beads; alternatively, asbestos, wollastonite; alternatively, fiberglass; alternatively, silica; alternatively, potassium titanate fibers; or alternatively, rockwool. Exemplary inorganic fillers can include, but are not limited to, aluminum flakes, zinc flakes, fibers of metals such as brass, aluminum, zinc, or any combination thereof; alternatively, aluminum flakes; alternatively, zinc flakes; or alternatively, fibers of metals such as brass, aluminum, and zinc. Exemplary organic fillers can include, but are not limited to, carbon fibers, carbon black, or any combination thereof; alternatively, carbon fibers; or alternatively, carbon black. Fibers such as glass fibers, milled fibers, carbon fibers and potassium titanate fibers, and inorganic fillers such as mica, talc, and clay can be incorporated into the composition, which can provide molded articles to provide a composition which can have improved properties.

In an aspect, any composition described herein, any mixture (general, first, second, or other) described herein, and/or any polymer composition (general, first, second, or other) can comprise a quantity of filler. In an embodiment, the maximum amount of filler utilized in any composition described herein, any mixture (general, first, second, or other) described herein, and/or any polymer composition (general, first, second, or other) can be 60 weight percent filler; alternatively, 55 weight percent filler; alternatively, 50 weight percent filler; alternatively, 45 weight percent filler; alternatively, 40 weight percent filler; alternatively, 35 weight percent filler; alternatively, 30 weight percent filler; or alternatively, 25 weight percent filler. In an embodiment, the minimum amount of filler utilized in any composition described herein, any mixture (general, first, second, or other) described herein, and/or any polymer composition (general, first, second, or other) can be 2 weight percent filler; alternatively, 5 weight percent filler; alternatively, 10 weight percent filler; alternatively, 15 weight percent filler; alternatively, 20 weight percent filler; alternatively, 25 weight percent filler; alternatively, 35 weight percent filler; alternatively, 40 weight percent filler; or alternatively, 45 weight percent filler. In an embodiment, the amount of filler utilized in any composition described herein, any mixture (general, first, second, or other) described herein, and/or any polymer composition (general, first, second, or other) can range from any minimum filler quantity disclosed herein to any maximum filler quantity described herein. In some non-liming embodiments, any composition described herein, any mixture (general, first, second, or other) described herein, and/or any polymer composition (general, first, second, or other) can comprise from 2 weight percent to 60 weight percent of the composition; or alternatively, 5 weight percent to 50 weight percent of the composition. Other quantities of filler that can be utilized in any composition described herein, any mixture (general, first, second, or other) described herein, and/or any polymer composition (general, first, second, or other) are readily apparent from the present disclosure. Generally, the weight percent of filler is based upon the total weight of the composition, mixture (general, first, second, or other), or polymer composition (general, first, second, or other).

In an aspect, a method of forming the composition can comprise contacting a polymer and carbamate; or alternatively, can comprise forming a reaction product of a polymer and a carbamate. In another aspect, the method of forming the composition can comprise melt processing a polymer and a carbamate; or alternatively, 1) contacting a polymer and a carbamate to form a mixture, and 2) melt processing the mixture. In another aspect, a method of forming a composition can comprise 1) contacting a) a melt processed mixture formed from a first mixture comprising i) a first polymer and ii) a carbamate, and b) a second polymer to form a second mixture and 2) melt processing the second mixture. In yet another, a method of forming a composition can comprise 1) contacting a first mixture comprising a first polymer and a carbamate, 2) melt processing the first mixture, 3) contacting the melt processed first mixture with a second polymer to form a second mixture, and 4) melt processing the second mixture. In a further aspect, a method of forming a composition can comprise 1) contacting a) a first mixture comprising i) a first polymer and ii) a carbamate, and b) a second polymer to form a second mixture, and 2) melt processing the second mixture. In some embodiments, the method of forming a composition can comprise contacting a carbamate with an at least partially melted polymer; alternatively, 1) melting at least a portion of the polymer, and 2) contacting a carbamate with the at least partially melted polymer. In an embodiment, the composition, whether it be a composition formed by contacting the polymer and carbamate, a composition formed by melt processing a mixture comprising the polymer and the carbamate, or composition which can comprise reaction product of the polymer and the carbamate, can be stored. The stored composition can be used at a later time.

In an aspect, a method of forming a composition can comprise contacting a) a polymer composition comprising, or consisting essentially of, a polymer and b) carbamate; or alternatively, forming a reaction product by contacting a) polymer composition comprising, or consisting essentially of, a polymer and b) a carbamate. In another aspect, the method of forming the composition can comprise melt processing a) a polymer composition comprising, or consisting essentially of, a polymer and b) a carbamate; or alternatively, 1) contacting a) a polymer composition comprising, or consisting essentially of, a polymer and b) a carbamate to form a mixture, and 2) melt processing the mixture. In another aspect, a method of forming a composition can comprise 1) contacting a) a melt processed mixture formed from a first mixture comprising i) a first polymer composition comprising, or consisting essentially of a first polymer and ii) a carbamate, and b) a second polymer composition comprising a second polymer to form a second mixture and 2) melt processing the second mixture. In yet another, a method of forming a composition can comprise 1) contacting a first mixture comprising a) a first polymer composition comprising, or consisting of a first polymer and b) a carbamate, 2) melt processing the first mixture, 3) contacting the melt processed first mixture with a second polymer composition comprising, or consisting essentially of, a second polymer to form a second mixture, and 4) melt processing the second mixture. In a further aspect, a method of forming a composition can comprise 1) contacting a) a first mixture comprising i) a first polymer composition comprising, or consisting essentially of, a first polymer and a ii) carbamate, and b) a second polymer composition comprising, or consisting essentially of, a second polymer to form a second mixture, and 2) melt processing the second mixture. In some embodiments, the method of forming a composition can comprise contacting a carbamate with an at least partially melted polymer composition; alternatively, 1) melting at least a portion of the polymer composition, and 2) contacting a carbamate with the at least partially melted polymer composition. In an embodiment, the composition, whether it be a composition formed by contacting the polymer composition and carbamate, a composition formed by melt processing a mixture comprising the polymer composition and the carbamate, or composition which can comprise reaction product of the polymer composition and the carbamate, can be stored. The stored composition can be used at a later time.

Generally and depending upon the particular method, the polymer (general, first, second, or other), the polymer composition (general, first, second, or other), the mixture (general, first, second, or other), and the carbamate (first, second, or other) are independent elements of the method. A particular method can be described utilizing any aspect or embodiment of the polymer described herein, any aspect or embodiment of the polymer composition described herein, any aspect or embodiment of the mixture described herein, and/or any aspect or embodiment of the carbamate described herein. Additional method features are independently described herein and any aspect or embodiment of these independent features can be utilized to further describe any applicable method of forming the composition described herein.

In an embodiment utilizing more than one polymer composition, the polymers of the polymer compositions can be the same. In other embodiment utilizing more than one polymer composition, two polymers of the polymer compositions can be different. Additionally, the form of the polymers (e.g., melt processed or non-melt processed, and/or cured or uncured, among other forms) utilized in the polymer compositions can be the same; or alternatively, different. In an embodiment utilizing a first polymer composition and a second polymer composition, the polymer of the first polymer composition and the polymer of the second polymer composition can be the same; or alternatively can be different. In some non-limiting embodiments utilizing a first polymer composition and a second polymer composition, the first polymer of the first polymer composition, the second polymer of the second polymer composition, or the first polymer of the first polymer composition and the second polymer of the second polymer composition can comprise, or consist essentially of, a poly(phenylene sulfide); or alternatively, the first polymer of the first polymer composition and the second polymer of the second polymer composition can comprise, or consist essentially of, a poly(phenylene sulfide). In other non-limiting embodiments utilizing a first polymer composition and a second polymer composition, utilizing a first polymer composition and a second polymer composition, the first polymer composition, the second polymer composition, or the first polymer composition and the second polymer composition can comprise, or consist essentially of, a poly(phenylene sulfide); or alternatively, the first polymer composition and the second polymer composition can comprise, or consist essentially of, a poly(phenylene sulfide).

In an embodiment, any polymer composition (general, first, second, or other) comprising a polymer (general, first, second, or other) and/or mixture (general, first, second, or other) can further comprise an additive. In an embodiment, a mixture formed by contacting (or alternatively, comprising) a polymer composition comprising a polymer and a carbamate can further comprise an additive. In another embodiment, a method of forming a composition can be a method wherein one or more of the first mixture, the second mixture, the first polymer composition, the second polymer composition further comprises one or more additives; alternatively, either the first mixture or the second mixture further comprises one or more additives; alternatively, both the first mixture and the second mixture further comprise one or more additives; alternatively, either the first polymer composition or the second polymer composition further comprises one or more additives; or alternatively, both the first polymer composition and the second polymer composition further comprise one or more additives. In an embodiment, a method described herein can include forming a mixture by contacting a) a polymer composition comprising a polymer, b) a carbamate, and c) an additive; alternatively, forming a first mixture by contacting a first polymer composition comprising a first polymer, b) a carbamate, and c) an additive; or alternatively, contacting a) a first mixture, b) a second polymer composition, and c) an additive. In some embodiments, the additive can be one or more additives. Additives (e.g., fire retardants, stabilizers, ultraviolet absorbers, lubricants, pigments, and/or fillers) are independently described herein and can be utilized without limitation as the one or more additives to describe a composition or method of forming a composition. In some embodiments, the one or more additives can comprise, or consist essentially of, a filler. Fillers are independently described herein and can be utilized without limitation to describe a composition or method of forming a composition.

In any method described herein, melt processing can occur at any point of the method. Additionally, melt processing can occur at more than one point in the method. Unless indicated otherwise, the polymer composition (or the polymer within the polymer composition) described herein can be in any form; for example the polymer composition (or the polymer within the polymer composition) can be melt processed; or alternatively, the polymer composition (or the polymer within the polymer composition) can be utilized without prior melt processing. In an embodiment wherein the polymer composition is contacted with a carbamate, the polymer composition (or the polymer within the polymer composition) can be melt processed before it is contacted with the carbamate; or alternatively, the polymer composition (or the polymer within the polymer composition) can be contacted with the carbamate before it melt processed. In an embodiment, regardless of whether or not the polymer composition (or the polymer within the polymer composition) and the carbamate is melt processed, the polymer composition can be optionally stored before subsequent processing. In yet other embodiments, the first mixture, regardless of whether it is melt processed and/or stored, can undergo further processing; e.g. addition of one or more additives.

In any embodiment contacting 1) a mixture comprising a) a first polymer composition comprising a first polymer and b) a carbamate and 2) a second composition comprising a second polymer composition, melt processing can occur at any stage of the method. Unless indicated otherwise, the first polymer and/or the second polymer utilized in any composition described herein can be in any form; for example the polymer (first or second) can be melt processed or utilized without prior melt processing. In an embodiment, the polymer (first or second) can be melt processed prior to contacting any other (if any) component of the polymer composition (first or second). Unless indicated otherwise, the first polymer composition comprising, or consisting essentially of, the first polymer (regardless of whether or not it is melt processed) can be in any form; for example, the first polymer composition can be melt processed or can be utilized without prior melt processing. In some embodiments, regardless of whether or not the first polymer is melt processed before contact with any other component of the first polymer composition, the first polymer composition comprising, or consisting essentially of, the first polymer can be melt processed prior to contact with the carbamate; or alternatively, the first polymer composition comprising, or consisting essentially of, the first polymer can be contacted with the carbamate before the first polymer composition is melt processed. In other embodiments regardless of whether or not a) the first polymer and/or b) the first polymer composition is melt processed, the mixture comprising a) the first polymer composition comprising the first polymer and b) the carbamate can be melt processed prior to contact with the second polymer composition comprising the second polymer; or alternatively, the first mixture comprising a) the first polymer composition comprising the first polymer and b) the carbamate can be contacted with the second polymer composition comprising the second polymer before the first mixture is melt processed. In an embodiment, regardless of whether or not a) the first polymer is melt processed, b) the first polymer composition comprising, or consisting essentially of, the first polymer is melt processed, and/or c) the first mixture is melt processed, the first mixture can be stored before subsequent processing (e.g., before contact with the second polymer composition; or alternatively, before forming a second mixture). Unless indicated otherwise, the second polymer composition comprising, or consisting essentially of, the second polymer (regardless of whether or not it is melt processed) can be in any form; for example the second composition can be melt processed or can be utilized without prior melt processing. In some embodiments, the second composition comprising, or consisting essentially of, the second polymer can be melted processed prior to contact with the first mixture; or alternatively, the second composition comprising, or consisting essentially of, the second polymer can be contacted with the first mixture before the second polymer is melt processed. In an embodiment, regardless of whether or not a) the first polymer is melt processed, b) the first polymer composition comprising, or consisting essentially of, the first polymer is melt processed, c) the first mixture is melt processed, d) the first mixture is stored before subsequent processing, e) the second polymer is melt processed, and/or f) the second polymer composition comprising, or consisting essentially of, the second polymer is melt processed, the second mixture comprising, or consisting essentially of, the first mixture and the second polymer composition can be melt processed; or alternatively, the second mixture comprising, or consisting essentially of, the first mixture and the second polymer composition can be utilized without prior melt processing. In other embodiments, regardless of whether or not a) the first polymer is melt processed, b) the first polymer composition comprising, or consisting essentially of, the first polymer is melt processed, c) the first mixture is melt processed, d) the first mixture is stored before subsequent processing, e) the second polymer is melt processed, f) the second polymer composition comprising, or consisting essentially of, the second polymer is melt processed, and/or g) the second mixture comprising the first mixture and the second polymer composition is melt processed, the second mixture comprising or consisting essentially of the first mixture and the second polymer composition can be stored before subsequent processing.

In an aspect, the method of forming a composition can utilize a masterbatch process. In a masterbatch process, a masterbatch composition can be prepared by contacting a first polymer composition (comprising, or consisting essentially of a first polymer) and carbamate (a first carbamate) at a first polymer to carbamate weight ratio greater than the polymer to carbamate weight ratio found in the ultimately formed composition. The masterbatch composition can then be contacted with a second polymer composition (comprising, or consisting essentially of, a second polymer) (or a second polymer composition and a second carbamate) and then processed into a composition having a polymer to carbamate weight ratio desired for the ultimately formed composition. In an embodiment, the masterbatch composition can be the first mixture (regardless of whether or not the first mixture has been melt processed). In some embodiments, the masterbatch composition can be stored before processing with the second polymer composition (or a second polymer composition and a second carbamate). In other embodiments, a second mixture can be formed by contacting the masterbatch composition (regardless of whether or not the first mixture has been melt processed, and/or stored) and a second polymer composition comprising a second polymer. In the masterbatch process, the masterbatch composition and the second polymer composition (or a second polymer composition and a second carbamate) can also comprise additives (e.g., a filler, among other additives). Alternatively, a second mixture comprising the masterbatch composition and the second polymer composition can further comprise additives (e.g., a filler, among other additives). Additives and carbamates are independently described herein and can be utilized without limitation to further describe the master batch composition formed from the polymer composition and the carbamate and/or the second polymer composition (or a second polymer composition and a second carbamate).

In any aspect or embodiment utilizing a second mixture, the second mixture can comprise, or consists essentially of, a) a second polymer (or second polymer composition comprising a second polymer) and b) a second carbamate; or alternatively, the second mixture can be formed by contacting a) a second polymer (or second polymer composition comprising a second polymer) and b) a second carbamate. In some embodiments, one or more additional compositions can be component of the polymer composition (general, first, second, or other); or alternatively, a mixture (general, first, second, or other) can also comprise one or more additional materials in addition to the polymer composition or the polymer composition and carbamate. In an embodiment, the one or more additional materials can comprise, or consist essentially of an additive. In an aspect, a composition, any mixture (general, first, second, or other) utilized in any method described herein, and/or polymer composition (general, first, second, or other) utilized in any method described herein can further comprise one or more additives. Additives (e.g., fire retardants, stabilizers, ultraviolet absorbers, lubricants, pigments, and/or fillers) are described herein and can be utilized without limitation to further describe any method described herein. In some embodiments, one or more of the a) first mixture, b) the second mixture, c) the first polymer composition, and/or d) the second polymer composition can further comprise any additive (general or specific) described herein. In other embodiments, one or more of a) the first mixture, b) the second mixture, c) the first polymer composition, and/or d) the second polymer composition can further comprise any filler (general or specific) described herein. The quantity(ies) of the additive(s) (or alternatively, filler) which can be utilized are provided herein and can be utilized without limitation to further described the method of forming the composition.

It should be noted that the carbamate and the polymer, or other components of the polymer composition, can react with the polymer, or other components, under some processing conditions (e.g., melt processing) to form a reaction product which may no longer have a carbamate functional group. Consequently, when referring to the polymer to carbamate weight ratios in any composition or method described herein, the polymer to carbamate weight ratios refer to the weight ratios of the utilized components and not any final weight ratio which can be measured or detected in the composition after it has been processed.

In an embodiment, the melt processing of mixture comprising a) a polymer composition comprising, or consisting essentially of, a polymer (first, second, or other), and b) a carbamate can form a composition comprising a reaction product of the polymer and the carbamate. It should be noted that a composition comprising a reaction product of the polymer and the carbamate can also comprise the polymer and/or the carbamate along with the reaction product of the polymer and the carbamate. In an embodiment, a first mixture comprising a) a polymer composition comprising, or consisting essentially or, a polymer (first, second, or other) and b) a carbamate, whether it has been melt processed or not, can be stored prior to contacting it with a second composition (or mixture).

In an embodiment, a second mixture can further comprise an additional carbamate (i.e., a carbamate beyond that utilized in the first mixture). In some embodiments, the additional carbamate can be the same carbamate that is utilized in the first mixture; alternatively, the additional carbamate can be a carbamate that is different than the carbamate in the first mixture. In other embodiments, a second mixture can be devoid of an additional carbamate (i.e., devoid of a carbamate beyond that utilized in the first mixture).

In an embodiment, the polymer of any polymer composition and the carbamate can be contacted at a polymer to carbamate weight ratio ranging from 1:1000 to 2:3. In some embodiments, the polymer of any polymer composition and the carbamate can be contacted at a polymer to carbamate weight ratio ranging from 1:1000 to 1:10; alternatively, from 1:500 to 1:20; or alternatively, from 1:200 to 1:50. In other embodiments, the polymer of any polymer composition and the carbamate can be contacted at a polymer to carbamate weight ratio ranging from 1:50 to 2:3; alternatively, 1:20 to 2:5; alternatively, from 8:100 to 1:6.

In an embodiment, any method described herein utilizing 1) a first mixture comprising a) a polymer composition comprising a first polymer and b) a carbamate and 2) a second polymer composition comprising a second polymer, the first polymer and the carbamate of the first mixture can be contacted at, or can form a mixture having, a first polymer to carbamate weight ratio ranging from 1:50 to 2:3; alternatively, 1:20 to 2:5; alternatively, from 8:100 to 1:6. In an embodiment, any method described herein utilizing a first mixture comprising a reaction product of the first polymer and the carbamate and a second polymer composition comprising a second polymer, the first mixture comprising a reaction product of the first polymer and the carbamate can be formed using a first composition polymer to carbamate weight ratio ranging from 1:50 to 2:3; alternatively, 1:20 to 2:5; alternatively, from 8:100 to 1:6. In an embodiment, any method described herein utilizing a first mixture comprising a) a first polymer composition comprising a first polymer and b) a carbamate or utilizing a first mixture comprising a reaction product of the first polymer and the carbamate, and second polymer composition comprising a second polymer, can use a total polymer (first polymer used in the first polymer composition plus the second polymer of the second polymer composition) to carbamate weight ratio ranging from 1:1000 to 1:10; alternatively, from 1:500 to 1:20; or alternatively, from 1:200 to 1:50.

In an aspect, the weight ratio of the second polymer in the second polymer composition to the first polymer in the first polymer composition can range from 1:1 to 50:1. In an embodiment, the weight ratio of the second polymer in the second polymer composition to the first polymer in the first polymer composition can range from 2:1 to 40:1; alternatively, from 3:1 to 30:1; or alternatively 5:1 to 20:1.

In an aspect, a composition, polymer composition (general, first, second, or other), and/or mixture (general, first, second, or other) can further comprise a filler. In an embodiment, the maximum amount of filler for any composition, polymer composition (general, first, second, or other), and/or mixture (general, first, second, or other) can be 80 weight percent filler; alternatively, 75 weight percent filler; alternatively, 70 weight percent filler; alternatively, 65 weight percent filler; alternatively, 60 weight percent filler; alternatively, 55 weight percent filler; alternatively, 50 weight percent filler; alternatively, 45 weight percent filler; alternatively, 40 weight percent filler; alternatively, 35 weight percent filler; or alternatively, 30 weight percent filler. In an embodiment, the minimum amount of filler for any composition, polymer composition (general, first, second, or other), and/or mixture (general, first, second, or other) can be 2 weight percent filler; alternatively, 5 weight percent filler; alternatively, 10 weight percent filler; alternatively, 15 weight percent filler; alternatively, 20 weight percent filler; alternatively, 25 weight percent filler; alternatively, 35 weight percent filler; alternatively, 40 weight percent filler; alternatively, 45 weight percent filler; alternatively, 50 weight percent filler; or alternatively, 55 weight percent filler. In an embodiment, the amount of filler in any composition, polymer composition (general, first, second, or other), and/or mixture (general, first, second, or other) can range from any minimum filler quantity disclosed herein to any maximum filler quantity described herein. In some non-liming embodiments, the melt processed mixture can comprise from 2 to 75 weight percent filler; alternatively, from 5 to 70 weight percent filler; from 10 to 60 weight percent filler; or alternatively, from 35 to 45 weight percent filler. Other filler amount ranges that can be utilized in the melt processed mixture are readily apparent from the present disclosure. Generally, the weight percent of filler is based upon the total weight of the composition, polymer composition (general, first, second, or other), and/or mixture (general, first, second, or other).

In an embodiment, the melt processing can be a step wherein at least part of the polymer composition or mixture is in molten form. In some embodiments, the melt processing can be performed by melting at least part of the polymer composition or mixture. In some embodiments, the melt processing step can be performed with externally applied heat. In other embodiments, the melt processing step itself can generate the heat necessary to melt (or partially melt) the mixture, polymer, or polymer composition. In an embodiment, the melt processing step can be an extrusion process, a melt kneading process, or a molding process. In some embodiments, the melt processing step of any method described herein can be an extrusion process; alternatively, a melt kneading process; or alternatively, a molding process. It should be noted, that when any process described herein employs more than one melt processing step, that each melt process step is independent of each other and thus each melt processing step can use the same or different melt processing method.

Not to be limited by theory, it is believed under melt processing conditions all or a portion of the carbamate can decompose to generate an isocyanate. When the carbamate has Formula 1, the produced isocyanate can have the formula R⁴(NCO)_{z}(NHCO₂R³)_{y-z} (Formula 3) wherein R³ can have any aspect or embodiment described herein, R⁴ can have any aspect or embodiment described herein, y can have any aspect or embodiment described herein, and z can be any integer ranging from 1 to y. When the carbamate has Formula 2, the produced isocyanate can have the formula Rₓ(R¹O)₃₋ₓSiR²NCO (Formula 4) wherein R can have any aspect or embodiment described herein, R¹ can have any aspect or embodiment described herein, R² can have any aspect or embodiment described herein, and x can have any aspect or embodiment described herein. Not to be limited further by theory, it is believed that the generated isocyanate can react with an isocyanate reactive group within the polymer to form a reaction product between the polymer and the isocyanate. In such a theoretical situation, the methods described herein can provide a processing advantage of working with a component that is more stable and has less health and toxicity concerns than an isocyanate. It is also possible that a reactive group in the polymer can displace one or more —OR³ groups (depending upon the actual carbamate utilized) via a transesterification mechanism. Further, it is possible that a reactive group in the polymer can displace one of more —OR¹ groups (depending upon the actual carbamate utilized) of the carbamate having Formula 2. Since there are more than one potential envisioned reaction paths between the polymer and the carbamate, and there can be other yet uncontemplated pathways, the reaction product, regardless of how it is formed, can be referred to as a reaction product of the polymer and the carbamate. Since the reaction between the polymer and the carbamate is only theory, any description of the composition or methods which does not specify the presence of a reaction product of the polymer and the carbamate is not to be construed to imply that a reaction product of the polymer and the carbamate is present and/or has been formed and likewise does not imply that the reaction product between the polymer and the carbamate is not present or has not been formed.

Melt processed compositions and/or mixtures comprising, or consisting essentially of, a) a polymer compositions comprising a polymer and b) a carbamate disclosed herein can have an improved physical or chemical property. In an embodiment, the melt processed compositions and/or mixtures comprising, or consisting essentially of, a) a polymer composition comprising a polymer and b) a carbamate can have an increased flexural property or an increased tensile property; alternatively, an increased flexural property; or alternatively, an increased tensile property. In some embodiments, the melt processed compositions and/or mixtures comprising, or consisting essentially of, a) a polymer composition comprising a polymer and b) a carbamate can have one or more increased properties selected from an increased flexural strength, an increased tensile strength, an increased break deflection, an increased elongation, an increased unnotched IZOD, an increased notched IZOD, or an increased maximum load strength. In other embodiments, the melt processed compositions and/or mixtures comprising, or consisting essentially of, a) a polymer composition comprising a polymer and b) a carbamate can have an increased flexural strength; alternatively, an increased tensile strength; alternatively, an increased break deflection; alternatively, an increased elongation; alternatively, an increased unnotched IZOD; alternatively, an increased notched IZOD; or alternatively, an increased maximum load strength.

In an embodiment, the melt processed compositions and/or mixtures comprising, or consisting essentially of, a) a polymer composition comprising a polymer and b) a carbamate can have reduced condensable gases. In some embodiments, the melt processed compositions and/or mixtures comprising, or consisting essentially of, a) a polymer composition comprising a polymer and b) a carbamate can have reduced corrosive agents.

The determinate of increased property, reduction in condensable gasses, and reduction in corrosive agents can be made by comparison of the melt process compositions and/or mixtures comprising, or consisting essentially of, a) a polymer composition comprising a polymer and b) a carbamate to a similar melt process composition which has not been prepared with a carbamate. The melt processed compositions and/or mixtures comprising, or consisting essentially of, a) a polymer composition comprising a polymer and b) a carbamate provided herein and/or produced by any of the methods described herein can be utilized to produce a finished product or molded article. Alternatively, a mixture comprising a) a polymer composition comprising a polymer and b) a carbamate can be directly subjected to a process (e.g. a molding process) which provides a finished product or a molded article. This finished product or molded article can be for consumer use, or can be for use as a component in a commercial or manufactured product. For example, these compositions can be used in the preparation of fibers, films, coatings, injection molding compounds, and fiber-reinforced composites. These compositions can be incorporated as a manufacturing component either alone or in a blend with other materials, such as other polymers, resins, reinforcing agents, additives, other thermoplastics, and the like. The processes that these compositions can be subject to can include any process known in the art, but are not limited to, heating, compounding, injection molding, blow molding, precision molding, filmblowing, and extrusion, among others. Alternatively, the polymer compositions or melt processed polymer compositions described herein can be stored for any period of time before being subjected to a process which provides a product such as those described above. Some embodiments provide a molded article produced from a polymer produced from or by any composition or method described herein.

### Substituent Groups

Various aspects and embodiments described herein refer to substituted groups. In an embodiment, each substituent of any aspect or embodiment calling for a substituent independently can be a halide, a hydrocarbyl group, or a hydrocarboxy group; alternatively, a halide or a hydrocarbyl group; alternatively, a halide or a hydrocarboxy group; alternatively, a hydrocarbyl group or a hydrocarboxy group; alternatively, a halide; alternatively, a hydrocarbyl group; or alternatively, a hydrocarboxy group. In some embodiments, each substituent of any aspect or embodiment calling for a substituent independently can be a halide, a C₁ to C₁₀ hydrocarbyl group, or a C₁ to C₁₀ hydrocarboxy group; alternatively, a halide or a C₁ to C₁₀ hydrocarbyl group; alternatively, a halide or a C₁ to C₁₀ hydrocarboxy group; alternatively, a C₁ to C₁₀ hydrocarbyl group or a C₁ to C₁₀ hydrocarboxy group; alternatively, a halide; alternatively, a C₁ to C₁₀ hydrocarbyl group; or alternatively, a C₁ to C₁₀ hydrocarboxy group. In other embodiments, each substituent of any aspect or embodiment calling for a substituent independently can be a halide, a C₁ to C₅ hydrocarbyl group, or a C₁ to C₅ hydrocarboxy group; alternatively, a halide or a C₁ to C₅ hydrocarbyl group; alternatively, a halide or a C₁ to C₅ hydrocarboxy group; alternatively, a C₁ to C₅ hydrocarbyl group or a C₁ to C₅ hydrocarboxy group; alternatively, a halide; alternatively, a C₁ to C₅ hydrocarbyl group; or alternatively, a C₁ to C₅ hydrocarboxy group.

In an embodiment, any halide substituent of any aspect or embodiment calling for a substituent can be a fluoride, chloride, bromide, or iodide; alternatively, a fluoride or chloride. In some embodiments, any halide substituent of any aspect or embodiment calling for a substituent can be a fluoride; alternatively, a chloride; alternatively, a bromide; or alternatively, an iodide.

In an embodiment, any hydrocarbyl substituent of any aspect or embodiment calling for a substituent can be an alkyl group, an aryl group, or an aralkyl group; alternatively, an alkyl group; alternatively, an aryl group; or alternatively, an aralkyl group. In an embodiment, any alkyl substituent of any aspect or embodiment calling for a substituent can be a methyl group, an ethyl group, an n-propyl group, an isopropyl group, an n-butyl group, a sec-butyl group, an isobutyl group, a tert-butyl group, an n-pentyl group, a 2-pentyl group, a 3-pentyl group, a 2-methyl-1-butyl group, a tert-pentyl group, a 3-methyl-1-butyl group, a 3-methyl-2-butyl group, or a neo-pentyl group; alternatively, a methyl group, an ethyl group, an isopropyl group, a tert-butyl group, or a neo-pentyl group; alternatively, a methyl group; alternatively, an ethyl group; alternatively, an isopropyl group; alternatively, a tert-butyl group; or alternatively, a neo-pentyl group. In an embodiment, any aryl substituent of any aspect or embodiment calling for a substituent can be phenyl group, a tolyl group, a xylyl group, or a 2,4,6-trimethylphenyl group; alternatively, a phenyl group; alternatively, a tolyl group; alternatively, a xylyl group; or alternatively, a 2,4,6-trimethylphenyl group. In an embodiment, any aralkyl substituent of any aspect or embodiment calling for a substituent can be benzyl group or an ethylphenyl group (2-phenyleth-1-yl or 1-phenyleth-1-yl); alternatively, a benzyl group; alternatively, an ethylphenyl group; alternatively, a 2-phenyleth-1-yl group; or alternatively, a 1-phenyleth-1-yl group.

In an embodiment, any hydrocarboxy substituent of any aspect or embodiment calling for a substituent can be an alkoxy group, an aryloxy group, or an aralkoxy group; alternatively, an alkoxy group; alternatively, an aryloxy group, or an aralkoxy group. In an embodiment, any alkoxy substituent of any aspect or embodiment calling for a substituent can be a methoxy group, an ethoxy group, an n-propoxy group, an isopropoxy group, an n-butoxy group, a sec-butoxy group, an isobutoxy group, a tert-butoxy group, an n-pentoxy group, a 2-pentoxy group, a 3-pentoxy group, a 2-methyl-1-butoxy group, a tert-pentoxy group, a 3-methyl-1-butoxy group, a 3-methyl-2-butoxy group, or a neo-pentoxy group; alternatively, a methoxy group, an ethoxy group, an isopropoxy group, a tert-butoxy group, or a neo-pentoxy group; alternatively, a methoxy group; alternatively, an ethoxy group; alternatively, an isopropoxy group; alternatively, a tert-butoxy group; or alternatively, a neo-pentoxy group. In an embodiment, any aryloxy substituent of any aspect or embodiment calling for a substituent can be phenoxy group, a toloxy group, a xyloxy group, or a 2,4,6-trimethylphenoxy group; alternatively, a phenoxy group; alternatively, a toloxy group; alternatively, a xyloxy group; or alternatively, a 2,4,6-trimethylphenoxy group. In an embodiment, any aralkoxy substituent of any aspect or embodiment calling for a substituent can be benzoxy group.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

Unless indicated otherwise, when a range of any type is disclosed or claimed, for example a range of the number of carbon atoms, molar ratios, temperatures, and the like, it is intended to disclose or claim individually each possible number that such a range could reasonably encompass, including any sub-ranges encompassed therein. For example, when describing a range of measurements such as molar ratios, every possible number that such a range could reasonably encompass can, for example, refer to values within the range with one significant digit more than is present in the end points of a range. In this example, a molar ratio between 1.03:1 and 1.12:1 includes individually molar ratios of 1.03:1, 1.04:1, 1.05:1, 1.06:1, 1.07:1, 1.08:1, 1.09:1, 1.10:1, 1.11:1, and 1.12:1. Applicants' intent is that these two methods of describing the range are interchangeable. Moreover, when a range of values is disclosed or claimed, which Applicants intend to reflect individually each possible number that such a range could reasonably encompass, Applicants also intend for the disclosure of a range to reflect, and be interchangeable with, disclosing any and all sub-ranges and combinations of sub-ranges encompassed therein. When describing a range in which the end points of the range have different numbers of significant digits, for example, a molar ratio from 1:1 to 1.2:1, every possible number that such a range could reasonably encompass can, for example, refer to values within the range with one significant digit more than is present in the end point of a range having the greatest number of significant digits, in this case 1.2:1. In this example, a molar ratio from 1:1 to 1.2:1 includes individually molar ratios of 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, and 1.20, all relative to 1, and any and all sub-ranges and combinations of sub-ranges encompassed therein. Accordingly, Applicants reserve the right to proviso out or exclude any individual members of any such group, including any sub-ranges or combinations of sub-ranges within the group, if for any reason Applicants choose to claim less than the full measure of the disclosure, for example, to account for a reference that Applicants are unaware of at the time of the filing of the application.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can suggest themselves to one of ordinary skill in the art without departing from the spirit of the present invention or the scope of the appended claims.

The data and descriptions provided in the following examples are given to show particular aspects and embodiments of the compounds, catalyst systems, and olefin oligomerization and/or olefin polymerization methods disclosed, and to demonstrate a number of the practices and advantages thereof. The examples are given as a more detailed demonstration of some of the aspects and embodiments described herein and are not intended to limit the disclosure or claims in any manner.

### EXAMPLES

The isocyanatosilanes, γ-isocyanatopropyltrimethoxysilane (GE Advanced Materials Y-5187—now available as Silquest® A-Link® 35 Silane) and γ-isocyanatopropyltriethoxysilane (GE Advanced Materials Y-1310—now available as Silquest® A-Link® 25 Silane), were utilized as obtained from the supplier. The silanes, γ-glycidoxypropyltrimethoxysilane (GE Advanced Materials A-187—now available as Silquest A-187® Silane) and γ-aminopropyltrimethoxysilane (GE Advanced Materials A-1110—now available as Silquest A-1110® Silane), were utilized as obtained from the supplier. Cured poly(phenylene sulfide) resin was sourced from Chevron Phillips Chemical Company, LP.

### Preparation of Methy-N-3-(Trimethoxysilyl)propylcarbamate

To a flask was added equal molar quantities of γ-isocyanatopropyltrimethoxysilane and methanol. The flask contents were briefly mixed and then allowed to stand undisturbed at room temperature for a minimum of 12 hrs. The conversion of the isocyanate to the carbamate was verified by Fourier Transform Infrared (FTIR) analysis. The FTIR spectrum of the γ-isocyanatopropyltrimethoxy-silane sample had a strong infrared peak at 2270 cm⁻¹ (within the isocyanate region of the infrared spectrum) and a very small infrared peak at 1726 cm⁻¹ (within the carbonyl region of the infrared spectrum). The product FTIR spectrum had no infrared peak at 2270 cm⁻¹ (within the isocyanate region of the infrared spectrum) and strong peaks at 1703 cm⁻¹ (within the carbonyl region of the infrared spectrum) along with an infrared peak at 1533 cm⁻¹ (within an amide region of the infrared spectrum) suggesting the conversion of the isocyanate to the carbamate.

### Preparation of Methyl-N-3-(Triethoxysilyl)propylcarbamate

Methyl-N-3-(triethoxysilyl)propylcarbamate was prepared using the same procedure as utilized for methyl-N-3-(trimethoxysilyl)propylcarbamate.

### Preparation and Testing of Polyphenylene Sulfide-Carbamate Compositions

Poly(phenylene sulfide), 2500 grams, and the carbamate, 0.099 moles, were combined and then mixed in a Henschel blender. The mixed compositions were then melt compounded using a single screw extruder and passed through a water bath prior to pelletization. The resulting pellets were then dried at 150° C. for at least 3 hours. The pellets were then molded to prepare test specimens for tensile properties, flexural properties, and Izod pendulum impact resistance in accordance with ASTM Methods D638-03, D790-03, and D256-03.

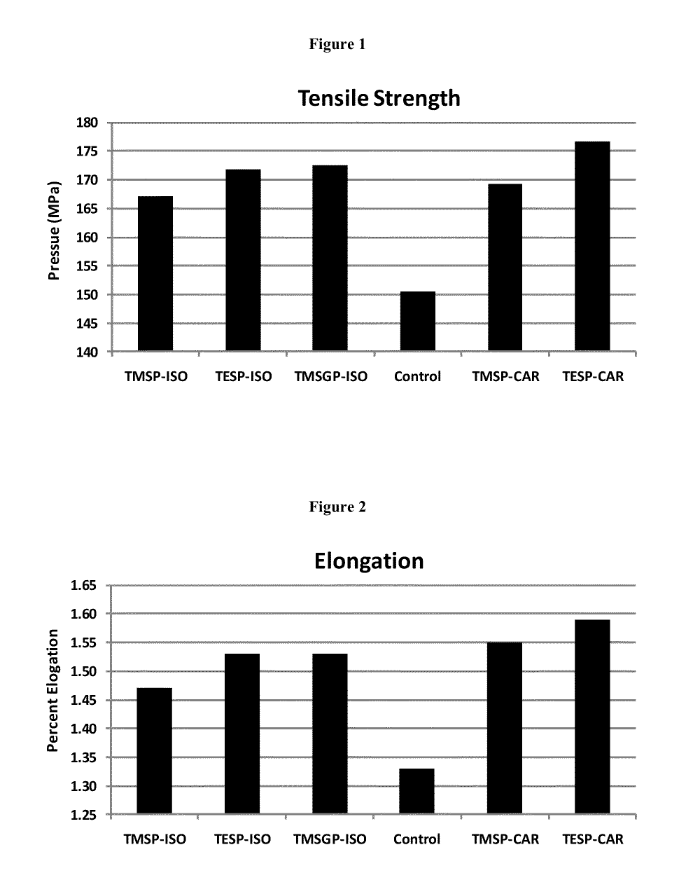

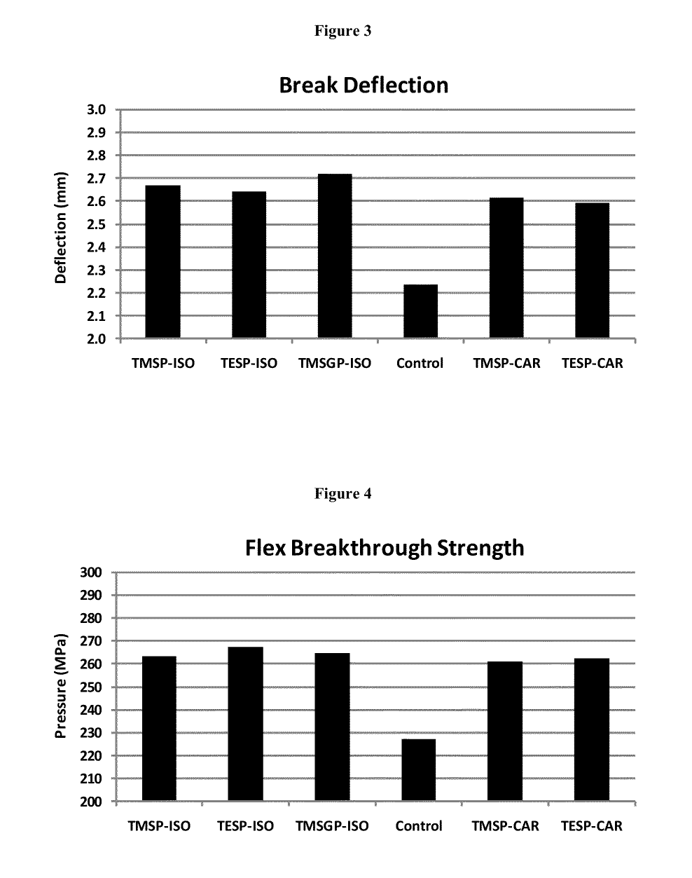

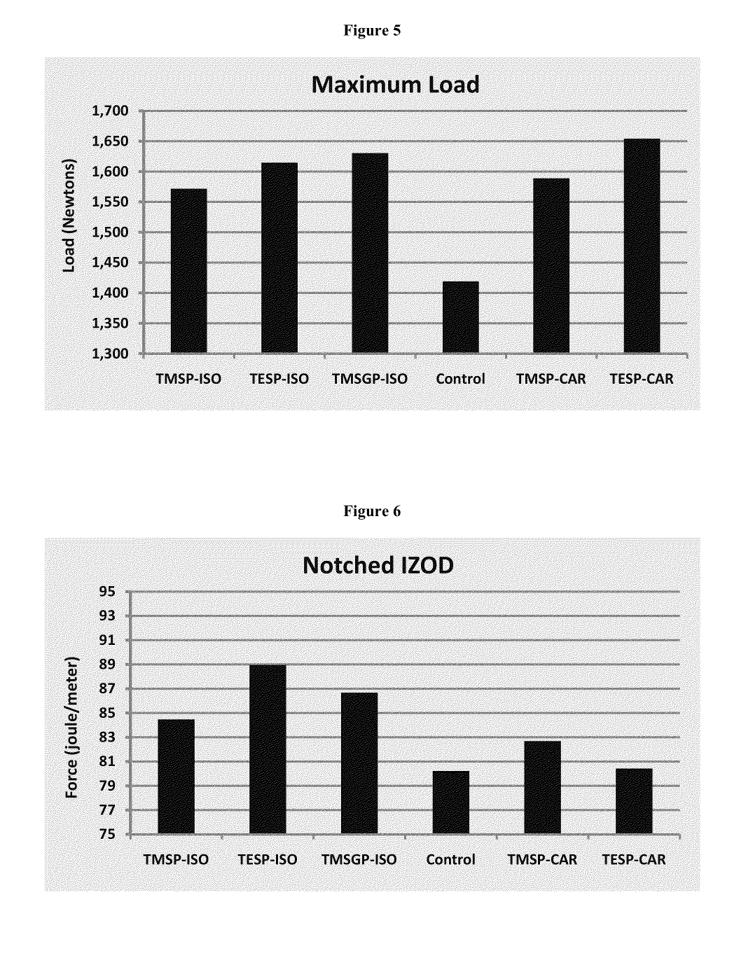

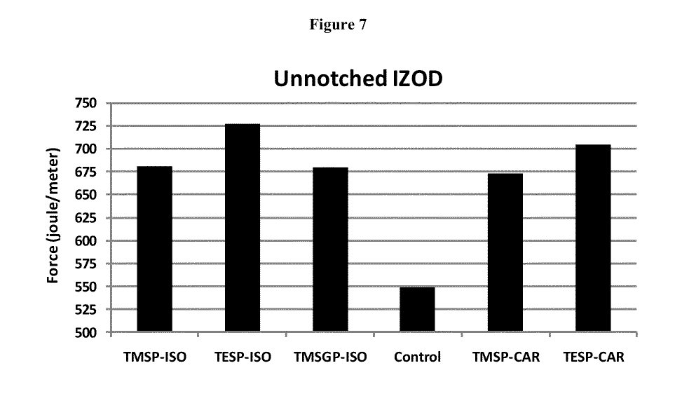

FIGS. 1-7 compares the tensile strength, elongation, flex break strength, break deflection, maximum load, notched IZOD, and unnotched IZOD, of the melt processed poly(phenylene sulfide)-carbamate compositions, melted processed poly(phenylene sulfide)-isocyanate composition, and control melt processed poly(phenylene sulfide) control that contained had no added carbamate or isocyanate. The tensile strength, elongation, flex break strength, break deflection, and maximum load data presented in FIGS. 1-5 represent the average value of five measurements for each melt processed poly(phenylene sulfide)-carbamate composition, melt processed poly(phenylene sulfide)-isocyanate composition, and melt processed poly(phenylene sulfide) control. The notched IZOD, and unnotched IZOD data presented in FIGS. 6-7 represent the average value of ten measurements for each melt processed poly(phenylene sulfide)-carbamate composition, melt processed poly(phenylene sulfide)-isocyanate composition, and melt processed poly(phenylene sulfide) control. These figures show that poly(phenylene sulfide) melt processed in the presence of a carbamate have equivalent properties to poly(phenylene sulfide) melt processed in the presence of an isocyanate.

All of the compositions and methods disclosed and claimed herein can be made and executed without undue experimentation in light of the present disclosure. While the compositions and methods of this invention have been described in terms of particular embodiments, it will be apparent to those of skill in the art that variations can be applied to the compositions and methods and in the steps or in the sequence of steps of the methods described herein without departing from the concept, spirit and scope of the invention as defined by the appended claims.

We claim:

1. A composition comprising:
a) a polymer composition comprising a poly(arylene sulfide), a poly(arylene sulfone), a copolymer of a poly(arylene sulfide) and a poly(arylene sulfone), or any combination thereof; and
b) a carbamate having the formula R⁴(NHCO₂R³)_{y} where y is 1, 2, or 3, R³ is a C₁ to C₁₀ organic group, and R⁴ is a C₁ to C₈₀ organic group.

2. The composition of claim 1, wherein R³ is a C₁ to C₁₀ hydrocarbyl group or a C₁ to C₁₀ substituted hydrocarbyl group, and R⁴ is a C₁ to C₃₀ hydrocarbon group or a C₁ to C₃₀ substituted hydrocarbon group.

3. The composition of claim 1, wherein R³ is a C₁ to C₁₀ hydrocarbyl group, y is 2, and R⁴ is a C₁ to C₃₀ hydrocarbylene group.

4. The composition of claim 1, wherein R³ is a C₁ to C₁₀ hydrocarbyl group, y is 1, and R⁴ is a C₁ to C₂₀ hydrocarbyl group.

5. The composition of claim 1, wherein R³ is a C₁ to C₁₀ hydrocarbyl group, y is 1, and R⁴ is a C₁ to C₂₀ hydrocarbylene group.

6. The composition of claim 1, wherein the polymer composition comprises polyphenylene sulfide, R³ is a C₁ to C₁₀ hydrocarbyl group, y is 1, and R⁴ is a C₁ to C₂₀ hydrocarbylene group.

7. The composition of claim 1, wherein y is 1 and R⁴ is Rₓ(R¹O)₃₋ₓSiR²—; and where x is 0, 1, 2, or 3; each R and R¹ independently is a C₁ to C₂₀ organic group; R² is a C₁ to C₂₀ organylene group; and R³ is a C₁ to C₁₀ organic group.

8. The composition of claim 7, wherein x is 0, 1, or 2; each R and R¹ independently is a C₁ to C₁₀ hydrocarbyl group; R² is a C₁ to C₁₀ hydrocarbylene group; and R³ is a C₁ to C₁₀ hydrocarbyl group.

9. The composition of claim 7, wherein x is 0; each R¹ is independently a methyl group or an ethyl group; R² is a methylene group, an ethylene group, or a propylene group; and R³ is a methyl group or an ethyl group.

10. The composition of claim 1, wherein the carbamate comprises methyl-N-3-(trimethoxysilyl)-propylcarbamate, ethyl-N-3-(triethoxysilyl)propylcarbamate, methyl-N-3-(triethoxysilyl)propyl-carbamate, methyl-N-3-(methyldimethoxysilyl)propyl-carbamate, ethyl-N-3-(methyldiethoxysilyl)-propylcarbamate, or any combination thereof.

11. The composition of claim 1, wherein the polymer composition comprises poly(phenylene sulfide), and the carbamate is methyl-N-3-(trimethoxysilyl)propylcarbamate, ethyl-N-3-(triethoxysilyl)-propylcarbamate, methyl-N-3-(triethoxysilyl)propylcarbamate, methyl-N-3-(methyldimethoxysilyl)-propylcarbamate, ethyl-N-3-(methyldiethoxysilyl)propylcarbamate, or any combination thereof.

12. The composition of claim 1, wherein the composition further comprises a fire retardant, a stabilizer, an ultraviolet absorber, a lubricant, a pigment, a filler, or any combination thereof.

13. A method of forming a composition comprising:
1) contacting
a) a polymer composition comprising a poly(arylene sulfide), a poly(arylene sulfone), a copolymer of a poly(arylene sulfide) and a poly(arylene sulfone), or any combination thereof; and
b) a carbamate having the formula R⁴(NHCO₂R³)_{y} where y is 1, 2, or 3, R³ is a C₁ to C₁₀ organic group, and R⁴ is a C₁ to C₈₀ organic group;
to form a mixture and
2) melt processing the mixture.

14. The method of claim 13, wherein the polymer composition comprises poly(phenylene sulfide); the carbamate comprises methyl-N-3-(trimethoxysilyl)propylcarbamate, ethyl-N-3-(triethoxysilyl)-propylcarbamate, methyl-N-3-(triethoxysilyl)propylcarbamate, methyl-N-3-(methyldimethoxysilyl)-propyl-carbamate, ethyl-N-3-(methyldiethoxysilyl)propylcarbamate, or any combination thereof; and the poly(phenylene sulfide) and the carbamate are contacted at a poly(phenylene sulfide) to carbamate weight ratio from 1:1000 to 2:3

15. The method of claim 13, wherein the polymer composition comprises poly(phenylene sulfide); the carbamate comprises methyl-N-3-(trimethoxysilyl)propylcarbamate, ethyl-N-3-(triethoxysilyl)-propylcarbamate, methyl-N-3-(triethoxysilyl)propylcarbamate, methyl-N-3-(methyldimethoxysilyl)-propyl-carbamate, ethyl-N-3-(methyldiethoxysilyl)propylcarbamate, or any combination thereof; and the poly(phenylene sulfide) and the carbamate are contacted at a poly(phenylene sulfide) to carbamate weight ratio from 1:50 to 2:3.

16. The method of claim 13, wherein the polymer composition comprises poly(phenylene sulfide); the carbamate comprises methyl-N-3-(trimethoxysilyl)propylcarbamate, ethyl-N-3-(triethoxysilyl)-propylcarbamate, methyl-N-3-(triethoxysilyl)propylcarbamate, methyl-N-3-(methyldimethoxysilyl)-propyl-carbamate, ethyl-N-3-(methyldiethoxysilyl)propylcarbamate, or any combination thereof; and the poly(phenylene sulfide) and the carbamate are contacted at a poly(phenylene sulfide) to carbamate weight ratio from 1:1000 to 1:10.

17. The method of claim 13, wherein the mixture further comprise a fire retardant, a stabilizer, an ultraviolet absorber, a lubricant, a pigment, a filler, or any combination thereof.

18. A method of forming a composition comprising:
1) contacting
a) a melt processed mixture formed from a first mixture comprising
i) a first polymer composition comprising a poly(arylene sulfide), a poly(arylene sulfone), a copolymer of a poly(arylene sulfide) and a poly(arylene sulfone), or any combination thereof, and
ii) a carbamate having the formula R⁴(NHCO₂R³)_{y} where y is 1, 2, or 3, R³ is a C₁ to C₁₀ organic group, and R⁴ is a C₁ to C₈₀ organic group;
b) a second polymer composition comprising a poly(arylene sulfide), a poly(arylene sulfone), a copolymer of a poly(arylene sulfide) and a poly(arylene sulfone), or any combination thereof
to form a second mixture; and
2) melt processing the second mixture.

19. The method of claim 18, wherein weight ratio of the first polymer to the second polymer ranges from 1:1 to 1:50.

20. The method of claim 18, wherein one or more of the first mixture, the second mixture, the first polymer composition, or the second polymer composition further comprises one or more additives.

21. The method of claim 18, wherein the one or more of the first mixture, the second mixture, the first polymer composition, or the second polymer composition further comprises a fire retardant, a stabilizer, an ultraviolet absorber, a lubricant, a pigment, a filler, or any combination thereof.

22. The method of claim 18, wherein the one or more of the first mixture, the second mixture, the first polymer composition, or the second polymer composition further comprises a filler.

23. The method of claim 18, wherein the one or more of the first mixture, the second mixture, the first polymer composition, or the second polymer composition further comprises glass fibers, milled fibers, glass beads, asbestos, wollastonite, fiberglass, mica, talc, clay, calcium carbonate, magnesium hydroxide, silica, potassium titanate, fibers rockwool, aluminum flakes, zinc flakes, fibers of metals, carbon fibers, carbon black, or any combination thereof.

24. The method of claim 18, wherein the composition comprises from 2 to 60 weight percent filler.

25. The method of claim 18, wherein the composition has an improved flexural property or a tensile property.

26. The method of claim 18, wherein the first polymer composition, the second polymer composition, or the first polymer composition and the second polymer composition comprises poly(phenylene sulfide).

27. A method of forming a composition comprising:
1) contacting
a) a first mixture comprising
i) a first polymer composition comprising a poly(arylene sulfide), a poly(arylene sulfone), a copolymer of a poly(arylene sulfide) and a poly(arylene sulfone), or any combination thereof, and
ii) a carbamate having the formula R⁴(NHCO₂R³)_{y} where y is 1, 2, or 3, R³ is a C₁ to C₁₀ organic group, and R⁴ is a C₁ to C₈₀ organic group, and
b) a second polymer composition comprising a poly(arylene sulfide), a poly(arylene sulfone), a copolymer of a poly(arylene sulfide) and a poly(arylene sulfone), or any combination thereof,
to form a second mixture; and
2) melt processing the second mixture.

28. The method of claim 27, wherein one or more of the first mixture, the second mixture, the first polymer composition, or the second polymer composition further comprises one or more additives.

29. The method of claim 27, wherein the composition comprises from 2 to 60 weight percent filler.

30. The method of claim 27, wherein the composition has an improved flexural property or a tensile property.

31. The method of claim 27, wherein the first polymer composition, the second polymer composition, or the first polymer composition and the second polymer composition comprises poly(phenylene sulfide).
